(19) United States
(12) Patent Application Publication
(10) Pub. No.: US 2025/0324372 A1
(43) Pub. Date: Oct. 16, 2025

(54) SIGNALING OF IN-DEVICE COEXISTENCE SUPPORT POLICIES

(71) Applicant: Cisco Technology, Inc., San Jose, CA (US)

(72) Inventors: Yogesh Kumar PALIWAL, Fremont, CA (US); Brian D. HART, Sunnyvale, CA (US); Binita GUPTA, San Diego, CA (US)

(21) Appl. No.: 19/173,708

(22) Filed: Apr. 8, 2025

Related U.S. Application Data
(60) Provisional application No. 63/633,528, filed on Apr. 12, 2024.
(60) Provisional application No. 63/721,234, filed on Nov. 15, 2024.

(51) Int. Cl. H04W 56/00; H04W 28/02; H04W 84/12

(52) U.S. Cl. CPC H04W 56/001; H04W 28/0289; H04W 84/12

(57) ABSTRACT

The present disclosure provides techniques for in-device coexistence (IDC) management. A first network device transmits an IDC policy announcement to a second network device, where the IDC policy announcement is received by a second network device, and the IDC policy announcement comprises one or more IDC policies supported by the first network device. The first network device monitors one or more characteristics of reported unavailability windows to determine whether the second network device violates the one or more IDC policies. In response to detecting a violation of the one or more IDC policies, the first network device transmits an IDC policy enforcement message to the second network device, the IDC policy enforcement message comprising a teardown frame to cancel the one or more IDC policies confirmed by the first network device.

### CROSS-REFERENCE TO RELATED APPLICATIONS

This application claims benefit of co-pending U.S. provisional patent application Ser. No. 63/633,528 filed Apr. 12, 2024; and co-pending U.S. provisional patent application Ser. No. 63/721,234 filed Nov. 15, 2024. The aforementioned related patent applications are herein incorporated by reference in their entirety.

### TECHNICAL FIELD

Embodiments presented in this disclosure generally relate to wireless communication. More specifically, embodiments disclosed herein relate to managing IDC in wireless networks through proactive or reactive policy announcements and policy-based enforcement.

### BACKGROUND

Smartphones, laptops, and other wireless client devices often integrate multiple communication technologies, such as Bluetooth (BT), Wi-Fi, and Ultra-Wideband (UWB), within a single device. However, these devices lack filtering and isolated medium access control (MAC) designs. When multiple radios operate simultaneously in overlapping or adjacent frequency bands, it may lead to interference and resource contention among the different wireless technologies. To mitigate these issues and improve performance across multiple services, client devices are configured to timeslice hardware resources, such as switching between Wi-Fi for infrastructure connections (e.g., Internet access via an access point (AP)) and Wi-Fi for peer-to-peer connections (e.g., wireless docking stations). However, this time-sharing approach introduces challenges in meeting existing IEEE standards, particularly in scenarios that require strict timing constraints for Wi-Fi communication.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example device with Bluetooth, ultra-wideband (UWB), and Wi-Fi coexistence, according to some embodiments of the present disclosure.

FIG. 2 depicts an example STA reporting an IDC unavailability window to a connected AP or peer STA, followed by subsequent updates to the unavailability window, according to some embodiments of the present disclosure.

FIG. 3A depicts an example IDC policy announcement that includes general IDC policies in a wireless network, according to some embodiments of the present disclosure.

FIG. 3B depicts an example IDC policy announcement that includes IDC policies specific to protocol sub-features in a wireless network, according to some embodiments of the present disclosure.

FIG. 3C depicts an example IDC policy announcement that includes IDC policies specific to communication links in a wireless network, according to some embodiments of the present disclosure.

FIG. 4 depicts an example interaction in which the associated AP or peer STA proactively announces its IDC policies to the requesting STA, according to some embodiments of the present disclosure.

FIG. 5 depicts an example interaction in which the associated AP or peer STA responds to IDC policy requests, according to some embodiments of the present disclosure.

FIG. 6 depicts an example method for an IDC requesting device to handle proactively announced IDC policies and report IDC unavailability windows to associated APs or peer STAs, according to some embodiments of the present disclosure.

FIG. 7 depicts an example method for an IDC management device to announce IDC policies proactively and enforce IDC mitigation when a violation is detected, according to some embodiments of the present disclosure.

FIG. 8 depicts an example method for an IDC requesting device to negotiate customized IDC policies and manage coexistence with associated APs or peer STAs, according to some embodiments of the present disclosure.

FIG. 9 depicts an example method for an IDC management device to negotiate customized IDC policies and manage coexistence with associated STAs, according to some embodiments of the present disclosure.

FIG. 10 is a flow diagram depicting an example method for IDC policy announcement and policy compliance monitoring, according to some embodiments of the present disclosure.

FIG. 11 is a flow diagram depicting an example method for IDC policy selection and unavailability reporting, according to some embodiments of the present disclosure.

FIG. 12 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including transmitting, by a first network device, an in-device coexistence (IDC) policy announcement to a second network device, the IDC policy announcement comprising one or more IDC policies supported by the first network device, monitoring, by the first network device, one or more reported unavailability windows to determine whether the second network device violates the one or more IDC policies, and in response to detecting a violation of the one or more IDC policies, transmitting, by the first network device, an IDC policy enforcement message to the second network device, the IDC policy enforcement message comprising a teardown frame to cancel the one or more IDC policies confirmed by the first network device.

One embodiment presented in this disclosure provides a method, including receiving, by a first network device, an in-device coexistence (IDC) service request from a second network device, the IDC service request comprising one or more IDC policies supported by the second network device, determining, by the first network device, one or more unavailability windows based on operational conditions of the first network device, and in response to the one or more IDC policies, transmitting, by the first network device, an IDC unavailability report to the second network device, the IDC unavailability report comprising at least one of the one or more unavailability windows during which the first network device is unable to communicate on a communication link.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

Smartphones, laptops, and other modern wireless client devices integrate multiple communication technologies into a single device. These technologies often share the same hardware resources without filtering or isolated MAC designs. The coexistence introduces challenges in managing radio resource allocation, particularly as wireless communication standards become increasingly time-sensitive in their response requirements.

Conventionally, client devices timeslice their hardware resources to improve performance across multiple services. This mechanism enables the device to dynamically switch between different wireless services to balance its data transmission needs. However, the time-sharing approach meets challenges as industry standards start to impose stricter timing constraints for response and data transmission. To meet these stricter timing requirements, a client device is expected to receive and/or respond to Wi-Fi frames within a short time window. When a device prioritizes other wireless traffic (e.g., Bluetooth, UWB, or off-channel Wi-Fi docking) over Wi-Fi for Internet access (e.g., via an AP), the device may fail to receive data units or respond within the required timeframes. One example of these timing constraints can be found in IEEE 802.11 standards, which require a client to receive physical layer convergence procedure (PLCP) service data units (PSDUs) at a PSDU error rate (PER) of 10% or lower, as well as to respond within short interframe spacing (SIFS) if an immediate response is solicited by a received frame. However, due to competing demands from other wireless traffic, the client may fail to receive the required PSDUs or be unable to transmit a response within the required SIFS. This failure may result in degraded Wi-Fi AP-to-client communication, such as increased retransmissions, degraded modulation and coding schemes (MCSs), and prolonged recovery time before the client can return to an optimal MCS.

These challenges highlight the need for improved in-device coexistence (IDC) management that can maintain reliable and efficient operation of multiple wireless technologies within a shared hardware environment. One potential approach involves allowing a non-access point (AP) station (STA) to signal an anticipated future unavailability window to an associated AP or peer STA (e.g., connected through Wi-Fi Direct, Bluetooth, or other wireless technologies). This enables the requesting STA to indicate when it expects to be unavailable due to the need to allocate hardware resources to another wireless technology (e.g., Bluetooth, UWB, or off-channel Wi-Fi docking). However, due to unexpected changes in system conditions, the initially reported unavailability window may need to be adjusted. For example, the unavailability window may need to be advanced, delayed, or extended in response to new interference patterns, application demands, or power constraints. To account for such changes, the requesting STA may send an updated unavailability window to the AP or peer STA, which overwrites the previously reported unavailability window. Such repetitive reporting provides flexibility, but also encourages STAs to speculatively or prematurely report unavailability windows since they can simply update the report later. As a result, the AP or peer STA may receive multiple IDC unavailability messages (e.g., updates per event), leading to excessive signaling traffic and increased interference.

The present disclosure introduces methods, systems, and apparatuses that further improve IDC management through the use of IDC policy announcement and unavailability window monitoring. Embodiments of the present disclosure improve network performance and multi-radio coexistence while minimizing signaling overhead and preventing excessive updates from overloading the network.

In one embodiment, proactive IDC policy advertising may be implemented, where an IDC managing device (e.g., an AP or peer STA) announces its IDC policies to all connected IDC requesting devices. As used herein, the IDC requesting device typically refers to an STA that operates multiple wireless technologies on shared hardware resources (e.g., Wi-Fi, Bluetooth, UWB). Due to the shared hardware environment, the IDC requesting device can benefit from IDC management to efficiently allocate resources among its different wireless interfaces. As used herein, the IDC management device (also referred to in some embodiments as the IDC responding device) is a device that connects to the IDC requesting device via one or more communication links. In one embodiment, the IDC management device may be an access point (AP) that manages IDC policies for an associated requesting STA within a Wi-Fi Basic Service Set (BSS). In one embodiment, the IDC management device may be a peer STA that communicates directly with the requesting STA (e.g., via Wi-Fi Direct, Bluetooth, or other short-range technology) or operates across multiple networks in a multi-link operation (MLO) setup. The peer STA communicates with the requesting STA to manage IDC policies and enforce coexistence rules to mitigate interference for the requesting STA (which operates multiple wireless technologies within a shared hardware environment). Under the proactive approach, the IDC management device announces IDC policies to associated STAs without first receiving a request. These proactively announced policies may define rules for unavailability window reporting (e.g., constraints on reporting updates before a previously signaled unavailability window has ended), restrictions on update frequency (e.g., limiting excessive signaling), and expected behaviors for IDC mitigation (e.g., maintaining availability on at least one link). By providing clear guidelines upfront (e.g., before data transmission), the AP or peer STA reduces speculative or excessive IDC unavailability reports from requesting STAs, improving efficiency and reliability in IDC management.

In another embodiment, reactive IDC policy advertising may be implemented. Instead of proactively announcing policies, the IDC management device (AP or peer STA) reacts to IDC mitigation requests from the requesting STA. Within the IDC mitigation request, the requesting STA may indicate that IDC mitigation is only valid for a defined period (rather than for the entire association session). This allows for more flexibility and adaptive IDC management, as the requesting device can request temporary IDC mitigation based on its immediate coexistence needs. Upon receiving the IDC mitigation request, the IDC management device evaluates the request based on network conditions and may either approve or refuse the request. In embodiments where the request is refused, the IDC management device may provide a reason code. If the IDC mitigation request is approved, the IDC management device may include, in the response, the IDC policies it supports to provide clear guidelines on how IDC mitigation should be handled.

In another embodiment, the IDC management device may actively monitor received IDC unavailability reports to ensure compliance with agreed-upon policies (or agreement). This monitoring may include tracking the frequency of received updates (to prevent excessive signaling) and verifying that the requesting STA follows agreed-upon IDC constraints (e.g., remaining active on at least one link when required) and performs data transmission based on the reported unavailability windows. Based on the monitoring, the IDC management device may determine whether the requesting STA complies with IDC policies. If a violation is detected, the IDC management device may perform enforcement actions, such as ignoring future IDC unavailability reports from the requesting STA for a defined period or reducing the STA's traffic priority to limit its impact on network performance. In embodiments where repeated violations occur, the IDC management device may send a teardown frame to revoke the agreed-upon IDC policies (or agreement) or disable the IDC mitigation privileges for the requesting STA entirely.

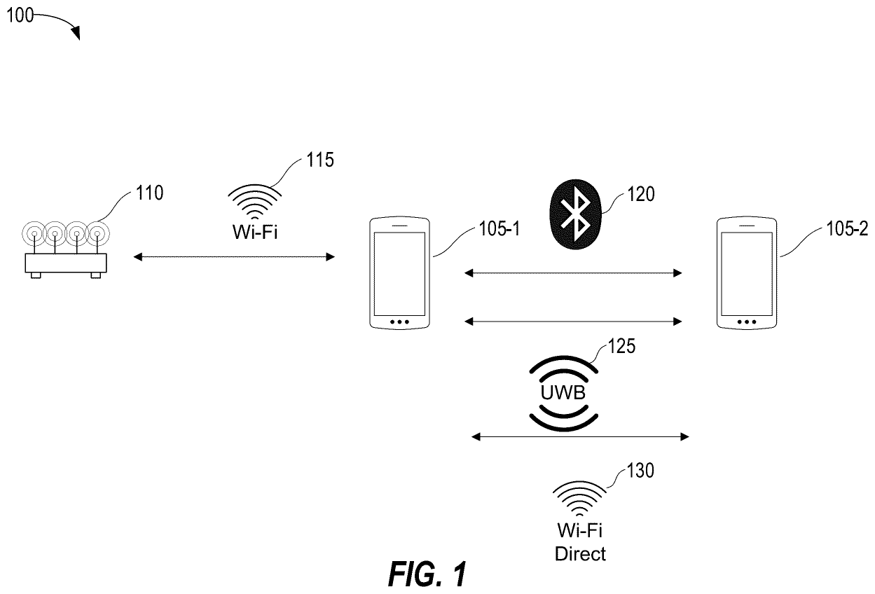

FIG. 1 depicts an example device 105-1 with Bluetooth, ultra-wideband (UWB), and Wi-Fi coexistence, according to some embodiments of the present disclosure.

As depicted, STA 105-1 connects to AP 110 as a client in a Wi-Fi BSS. Through this Wi-Fi connection 115, STA 105-2 gains access to the broader network infrastructure (e.g., Internet). This connection follows Wi-Fi infrastructure mode, where AP 110 manages the communication between STA 105-1 and other devices on the network and coordinates transmission timing and resource allocation.

As depicted, STA 105-1 also maintains direct connections with peer STA 105-2 using Bluetooth 120, Ultra-Wideband (UWB) 125, and Wi-Fi Direct 130. The Bluetooth connections 120 between STA 150-1 and STA 105-2 enable low-power, short-range data exchange, such as audio streaming, peripheral device pairing, or file transfers. The UWB connections 125 allow high-precision spatial awareness and data synchronization, which may be used for indoor positioning, secure keyless access, or high-speed data transfer between the two devices 105-1 and 105-2. The Wi-Fi Direct 130 facilitates high-speed and medium-range data transfer, such as sharing large files or streaming high-quality media between devices.

In this figure, STA 105-1 is depicted as a mobile phone, which is provided for conceptual clarity. In some embodiments, STA 105-1 may be any other wireless communication devices, such as laptops, tablets, smartwatches, or any other portable or stationary devices configured with multiple wireless communication technologies.

The depicted wireless technologies, including Wi-Fi for infrastructure connections 115, Bluetooth 120, UWB 125, and Wi-Fi Direct 130, are provided as examples for conceptual clarity. In some embodiments, STA 105-1 may support additional wireless communication interfaces, including Wi-Fi for off-channel docking (used for wireless display mirroring, data transfer, or peripheral connections to a docking station) or Near Field Communication (NFC) (for short-range authentication and data exchange). In some embodiments, STA 105-1 may utilize an MLO setup, where the device 105-1 maintains simultaneous connections to AP 110 over multiple frequency bands. For example, the STA 105-1 may establish three concurrent links with AP 110, including one link on the 2.4 GHz band (for longer range and lower power consumption), one link on the 5 GHz band (for higher throughput and reduced interference), and one link on 6 GHz band (for ultra-fast and low-latency communication). In some embodiments, the STA 4105-1 may maintain one link (e.g., 2.5 GHz) to AP 110 and another link (e.g., 5 GHz) to STA 105-2 for peer-to-peer (P2P) communication.

As depicted, since STA 105-1 integrates multiple wireless technologies within a shared hardware environment, the device requires in-device coexistence (IDC) management to efficiently allocate resources between Wi-Fi 115, Bluetooth 120, UWB 125, and Wi-Fi Direct 130. Without proper coordination, simultaneous transmissions across these radios may cause interference and degrade the overall network performance. To mitigate interference, STA 105-1 may need assistance from AP 110 and STA 105-2 in managing wireless coexistence and reducing conflicts between different communication protocols.

To facilitate IDC mitigation, STA 105-1 may report unavailability windows to AP 110 or STA 105-2, informing them when the device 105-1 expects to allocate resources to another technology (e.g., pausing Wi-Fi transmission to prioritize Bluetooth). However, since the unavailability windows are predicted in advance, actual conditions may change, requiring STA 105-2 to send updates to modify the reported windows. If STA 105-1 sends these updates too frequently or excessively, it can lead to increased signaling overhead, which may cause network congestion and additional processing burden for AP 110 or STA 105-2.

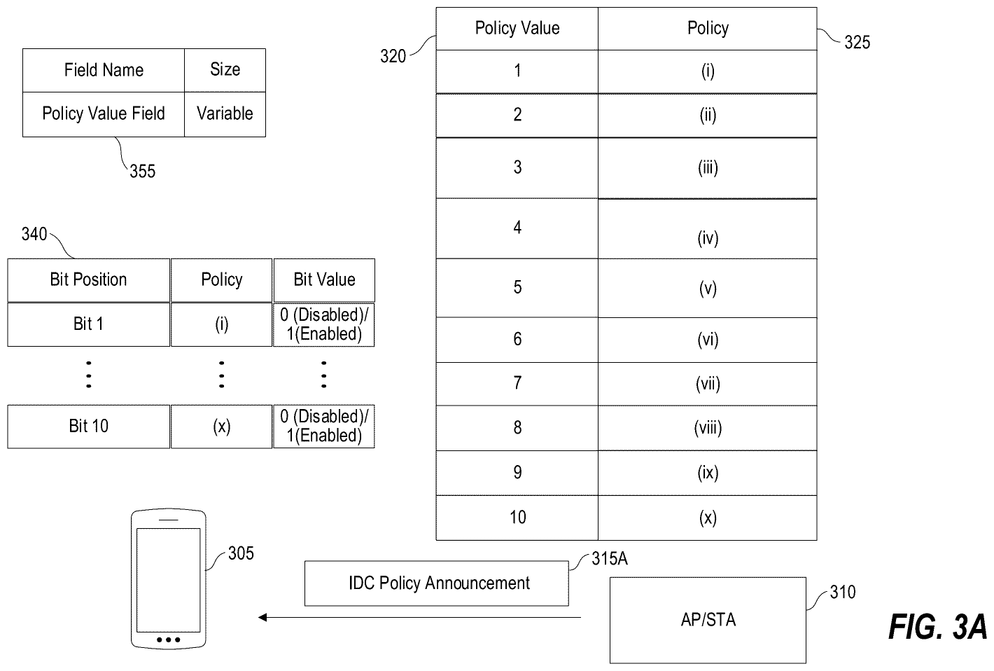

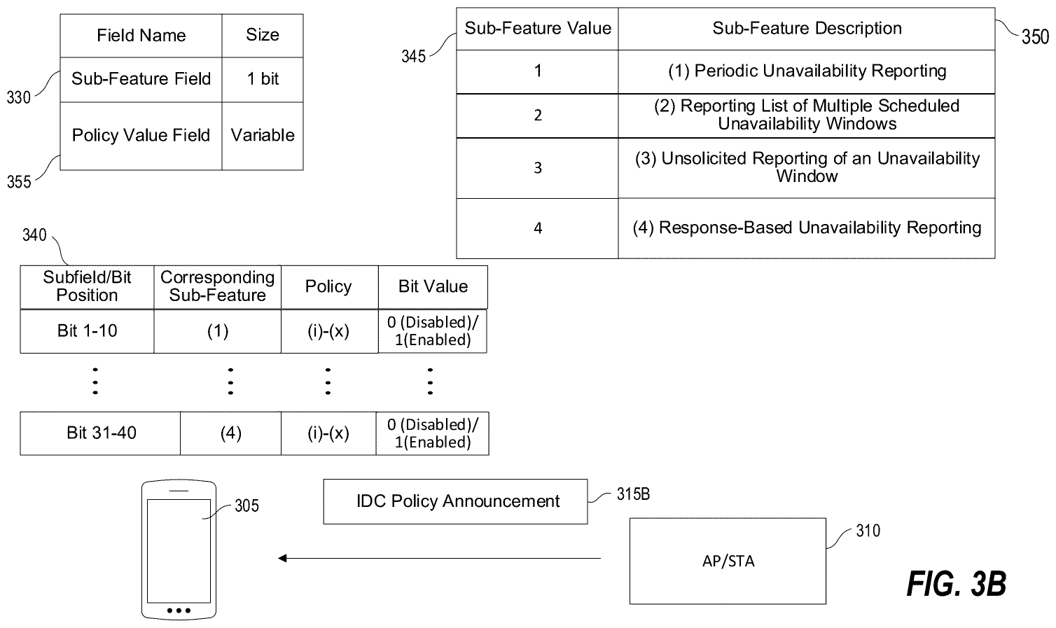

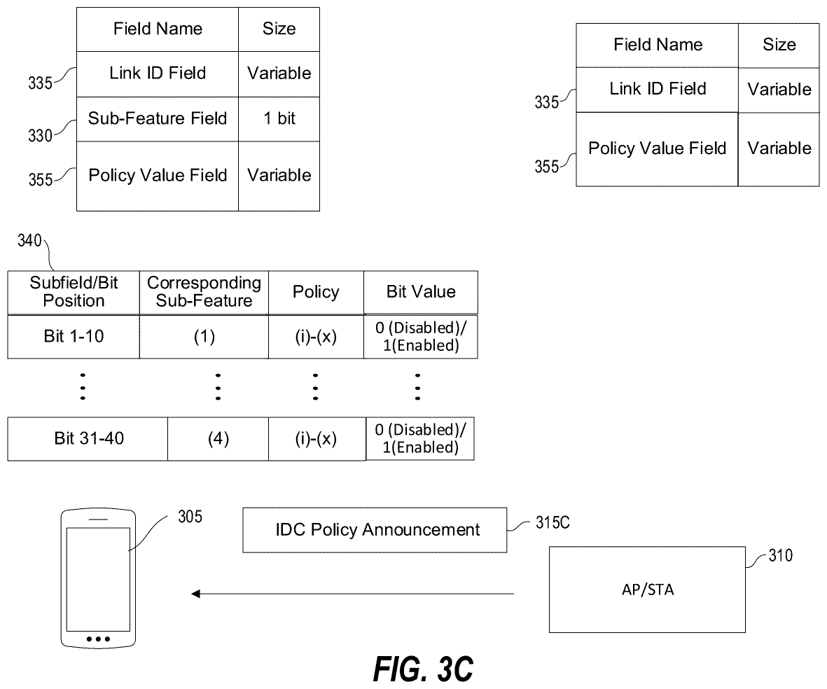

To avoid such excessive signaling, AP 110 or STA 105-2 may implement IDC policy management through either proactive or reactive approaches. Further details about proactive and reactive IDC policy management are discussed below with references to FIGS. 3-7.

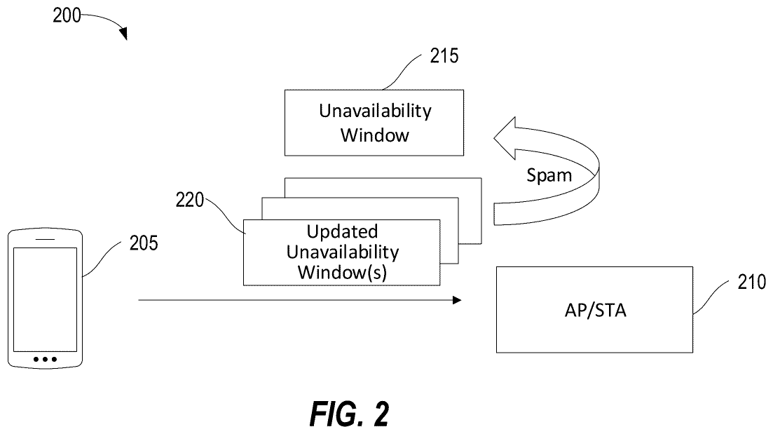

FIG. 2 depicts an example STA 205 reporting an IDC unavailability window 215 to a connected AP or peer STA 210, followed by subsequent updates 220 to the unavailability window, according to some embodiments of the present disclosure.

As depicted, STA 205 (which may correspond to STA 105-1 of FIG. 1) reports an unavailability window 215 to AP 210 (which may correspond to AP 110 of FIG. 1). The report may indicate the time period during which STA 205 expects to be unavailable for Wi-Fi communication due to the need to allocate resources to another wireless technology (e.g., Bluetooth or UWB communication). The time period may be specified as either a start time and an end time or a start time with a duration. STA 205 may use a management frame to report its unavailability window to AP 210, such as a (Re)Association Request frame, an operating model notification (OMN) frame, or a specific frame designed for IDC mitigation reporting. In some embodiments, the device receiving the unavailability window may be a peer STA (which corresponds to STA 105-2 of FIG. 1) that maintains a direct connection with STA 205, such as in a Wi-Fi Direct, Bluetooth, or UWB communication setup.

In some embodiments of the present disclosure, “(Re)Association” and similar terms refers to both “association” as well as “re-association.” For example, a “(Re)Association Response frame” may refer to an “Association Response frame,” a “Re-Association Response frame,” or both. Similarly, in some aspects, “association” may refer to an initial association and/or a re-association.

The reported unavailability window is predictive in nature, estimated by STA 205 based on its anticipated demand for non-Wi-Fi communication. The prediction may be based on various factors, including but not limited to, the expected Bluetooth/UWB activities, power management constraints, or scheduled tasks requiring a different radio interface. When any of these factors change, the relevant unavailability window may need to be updated. As depicted, STA 205 transmits an updated report 220 to modify the originally reported time. However, when updates 220 are sent too frequently (e.g., exceeding a defined limit), AP 210 may interpret these excessive updates 220 as signaling spam and choose to ignore them. This could cause many problems. For example, if AP 210 disregards new unavailability updates, AP 210 may continue operating under the previously reported window, which may no longer be accurate. This may lead to suboptimal scheduling decisions or even failed packet delivery. In P2P communication embodiments (e.g., Wi-Fi Direct, Bluetooth, or UWB links between STA 205 and a peer STA), failure to correctly handle unavailability updates may cause unexpected disconnections or degraded communication reliability.

To prevent excessive updates from overloading the network while maintaining accurate unavailability reporting, AP 210 (or a peer STA) may adopt proactive or reactive IDC policy enforcement mechanisms. Further details on IDC policy management strategies are discussed below with references to FIGS. 3-7.

FIG. 3A depicts an example IDC policy announcement 315A that includes general IDC policies in a wireless network, according to some embodiments of the present disclosure.

The AP (or a peer STA) 310 (which may correspond to AP 110 of FIG. 1, STA 105-2 of FIG. 1, or AP/STA 210 of FIG. 2) announces its supported IDC policies to the requesting STA 305 (which may correspond to STA 105-1 of FIG. 1 or STA 205 of FIG. 2). The IDC policy announcement (or advertisement) 315A may be transmitted using a management frame, such as Beacon frames, Probe Response frames, or OMN frames. These management frames may contain a UHR Operation element (for APs) or a UHR Capabilities element (for non-AP STAs). Within these elements, there is a Policy Value Field 355 that indicates the IDC policies supported by the AP (or peer STA) 310.

As depicted, each IDC policy 325 is assigned a respective value 320. The Policy Value field 355 may have a variable length and include one or more policy identifiers 320. In some embodiments, the Policy Value field may be a 4-bit field, where each policy is represented by a 4-bit identifier. In embodiments where the AP (or peer STA) advertises multiple IDC policies, the Policy Value field 355 may be structured as a concatenated list of 4-bit fields, where each 4-bit segment corresponds to a predefined policy. In embodiments where the AP/STA 310 supports two or more policies and offers them for selection, STA 305 may send an acknowledgement back to communicate the selected policy, so that both devices 305 and 310 operate under a mutually recognized IDC framework. However, if the AP-supported policies are mandatory and the STA 305 must follow without negotiation, no acknowledgement is needed, and the STA 305 may proceed to report unavailability windows directly.

In addition to policy selection through acknowledgement, an agreement may also be explicitly negotiated between STA 305 and AP/STA 310. In such embodiments, STA 305 may send an IDC policy request to propose a customized IDC agreement. The proposed IDC agreement may include policies that align with the AP's broadcasted policies (or requirements) (e.g., policies (i)-(x)) while incorporating specific constraints or requirements adapted to STA's 305 operational needs.

As used herein, a “policy” may refer to a rule with general applicability to all peers. That is, if a rule is broadcast/applied to all STAs regardless of agreement or negotiation, it may be referred to as a “policy.” Similarly, as used herein, an “agreement” may refer to a rule that has been negotiated or otherwise agreed upon with one or more particular peers. That is, if the rule has been agreed upon by a given STA (but may or may not be applied to other STAs), the rule may be referred to as an “agreement.”

As depicted, the IDC policies 325 may include a variety of rules or restrictions. For example, the policies may include: (i) no constraints on unavailability signaling by the requesting STA 305; (ii) the requesting STA 305 should remain available on at least one other link while a link is unavailable; (iii) the AP (or peer STA) 310 restricts the requesting STA 305 from sending an unavailability update before the previously signaled unavailability window has expired; (iv) the AP (or peer STA) 310 restricts the requesting STA 305 from sending an unavailability update if the transmission exceeds a defined threshold (e.g., within a defined interval); (v) instead of restricting the requesting STA 305, the AP (or peer STA) 310 ignores any updates sent by the requesting STA 305 before the previously signaled unavailability window has expired; (vi) the AP (or peer STA) 310 ignores excessive unavailability updates if the transmission exceeds a defined frequency threshold (e.g., within a defined interval); (vii) the AP (or peer STA) 310 disables the function of providing IDC mitigation to the requesting STA 305; (viii) the requesting device 305 can only signal IDC unavailability within a defined maximum duty cycle percentage (e.g., at most 10% of the time within a given interval); (ix) the requesting device 305 must remain available in a low-power listen mode on a backup link during an IDC unavailability window on its primary link; and (x) the requesting device 305 must ensure that IDC transmissions are restricted to channels that conform to a list of recommended channels for peer-to-peer (P2P) device usage, as specified by the AP (or STA) 310.

Each of the IDC policies 325 may be encoded using either a value-based encoding or a position-based encoding. In value-based encoding, each policy 325 is assigned a respective numerical value 320, and the Policy Value field 335 may be a fixed 4-bit field or be structured as a concatenated list of 4-bit fields. As depicted, a value of 1 is assigned to policy (i), a value of 2 is assigned to policy (ii), a value of 3 is assigned to policy (iii), and so forth, with a value of 10 being assigned to policy (x). The Policy Value field 355 may include one or more values, allowing the AP (or peer STA) 310 to enforce multiple policies concurrently. For example, if the AP (or peer STA) supports both policy (ii) and (iii), the Policy Value field 355 may include the corresponding assigned values (2 and 3).

In the position-based encoding, the Policy Value field 355 may be implemented as a bitmask, where each bit 340 corresponds to a predefined IDC policy based on its bit position within the Policy Value field 355. In this configuration, a bit value of 1 indicates that the corresponding policy is enabled, while a bit value of 0 indicates that the policy is disabled. For example, if the AP (or peer STA) 310 supports policies (ii), (iii), and (x), it may set bits 2, 3, and 10 to 1 in the policy value field.

Some of the listed policies cannot be enforced simultaneously due to logical conflicts. For example, policy (i) (no constraints) cannot be enforced along with any restrictive policies, such as policies (ii)-(x). Policy (ii) (remain available on at least one link) and policy (ix) (remain available in low-power listen mode on a backup link) cannot be enforced simultaneously. This is because policy (ii) requires a full link to remain active, whereas policy (ix) only requires the device to be in low-power listen mode on an alternative link. In embodiments where IDC is mandatory, policy (vii) (support for a peer's use of unavailability signaling is disabled) cannot be enforced. However, when IDC is optional, policy (vii) can be enforced, and the AP (or peer STA) 310 may choose not to support IDC signaling for certain devices.

The depicted IDC policy announcement (or advertisement) 315A advertises general policies supported by AP (or peer STA) 310 without specifying policies for a specific communication link or IDC protocol sub-feature. These general policies define network-wide IDC management rules that apply broadly to all STAs within the network or all peers within a peer-to-peer (P2P) communication setup. In some embodiments, IDC policy announcements may be more specific, targeting either certain IDC protocol sub-features or specific communication links associated with the requesting device. More details regarding the granular policy advertisements are discussed below with reference to FIGS. 3B and 3C.

FIG. 3B depicts an example IDC policy announcement 315B that includes IDC policies specific to protocol sub-features in a wireless network, according to some embodiments of the present disclosure.

Unlike the general IDC policies advertised in FIG. 3A, which apply broadly across the network, the IDC policy announcement (or advertisement) 315B provides granular advertisement by specifying policies for different IDC protocol sub-features. As used herein, an IDC protocol sub-feature refers to a specific reporting mechanism that defines how the IDC requesting device reports unavailability windows to the IDC management device. Examples of IDC protocol sub-features 350 include: (1) periodic unavailability reporting (where the requesting STA 305 reports unavailability windows at fixed interval, such as every 100 ms), (2) reporting of a list of multiple scheduled unavailability windows at once (where the requesting STA 305 pre-defines and reports multiple upcoming unavailability windows in a single message), (3) unsolicited reporting of an unavailability window (one at a time) (where the requesting STA 305 sends an unavailability window report dynamically whenever a new conflict arises), and (4) response-based unavailability reporting (where the requesting device 305 only reports an unavailability window when responding to a control or management frame from the AP or peer STA 310).

Since different reporting mechanisms may introduce different types of network load and interference, the IDC management device (AP or peer STA 310) may enforce different IDC policies based on the sub-feature used. For example, sub-features like periodic unavailability reporting and reporting a list of scheduled windows follow a structured format. Therefore, more flexible policies may be applied, such as no constraints on the unavailability window (e.g., policy (i)) or imposing a duty cycle limit (e.g., policy (ix)). For unsolicited reporting and response-based reporting, which may result in frequent, unpredictable updates, more restrictive policies may be applied to limit excessive updates, such as restricting updates when exceeding a defined threshold (e.g., policy (iv)) or ignoring updates before a previously signaled unavailability window has ended (e.g., policy (v)).

For each IDC protocol sub-feature, AP (or peer STA) 310 may specify two or more applicable IDC policies in the announcement (or advertisement) 315B. Rather than enforcing a single predetermined policy, this approach provides flexibility by allowing the requesting STA 305 to select and confirm the policy it agrees to follow. By including multiple policies per sub-feature, the AP (or peer STA) 310 allows different types of requesting devices 305 with varying operational requirements to negotiate an appropriate IDC policy. For example, a low-power device may prefer a duty cycle limit (e.g., policy (viii)) over a strict update restriction (e.g., policy (iv)). A performance-focused device may prioritize remaining fully active on at least one link (e.g., policy (ii)) instead of entering low-power listen mode (e.g., policy (ix)).

As discussed above, the IDC policy announcement (or advertisement) 315B may be divided in a management frame, such as a Beacon frame, Probe Response frame, or OMN frame. These management frames may contain a UHR Operation element (for APs) or a UHR Capabilities element (for non-AP STAs or UHR STAs). To indicate IDC policies specific to a sub-feature, these elements may be encoded using either a type-value encoding structure or a position-based encoding structure.

In one embodiment, such as when the type-value encoding is implemented, the UHR element includes a Sub-Feature field 330 and a Policy Value field 355. In some embodiments, the Sub-Feature field 330 may be a 2-bit field that identifies the IDC protocol sub-feature 350 to which the policy applies, with a respective value 345 assigned to each sub-feature. For example, a value of 1 is assigned to the periodic unavailability reporting, a value of 2 is assigned to the reporting of a list of scheduled unavailability windows, a value of 3 is assigned to the unsolicited reporting, and a value of 4 is assigned to the response-based reporting.

In some embodiments, the Policy Value field 355 may be a 4-bit field that specifies a policy supported by the AP/STA 310 for the corresponding sub-feature. When multiple policies are advertised, the Policy Value field 355 may be structured as a concatenated list of 4-bit fields, where each 4-bit segment corresponds to a predefined policy value 325 (as discussed above with reference to FIG. 3A).

In embodiments where policies for two or more sub-features are transmitted, the AP (or peer STA) 310 may construct the UHR element to include a structure format where each sub-feature field 330 is followed by its corresponding Policy Value field 355. The format follows a repeating structure to ensure that multiple sub-features can be efficiently communicated in a single announcement 315B. The element may begin with an Element ID field, which identifies the type of element (e.g., UHR Operation element for an AP or UHR Capabilities element for an STA). Following this, a Length field may be included to indicate the total size of the element. The length may vary based on the number of sub-features and policies included. Each sub-feature field 330 represents a specific IDC protocol sub-feature, such as periodic reporting, reporting of a list of scheduled unavailability windows, unsolicited reporting of an unavailability window (one at a time), or response-based reporting. The Policy Value field 355 immediately follows the sub-feature field 330 and specifies two or more policies supported by the AP (or peer STA) 310 for that sub-feature. Within the element, each sub-feature is paired with its corresponding policy value. For example, if the AP 310 advertises policies for three different sub-features, the UHR elements may be structured as follows: the first sub-feature field 330-1 that identifies periodic reporting (e.g., assigned value 1); the first Policy Value field 355-1 that follows the first sub-feature field 330 and specifies that the AP supports policy (i) (no constraints) and policy (viii) (a maximum duty cycle limit) for periodic reporting; the second sub-feature field 330-2 that identifies unsolicited reporting (e.g., assigned value 3); the second Policy Value field 355-2 that follows the second sub-feature field 330-2 and includes policy (iv) (restrict excessive updates) and policy (vi) (ignore updates exceeding a defined threshold); the third sub-feature field 330-3 that identifies response-based reporting (e.g., assigned value 4); the third Policy Value field 355-3 that follows the third sub-feature field 330-2 and includes policy (ii) (remain available on at least one link) and policy (iii) (restrict updates before a previous window ends).

In another embodiment, a position-based encoding approach may be used, where the Sub-Feature field 330 is omitted, and instead, the position of bits 340 within the Policy Value field 355 identifies the corresponding IDC protocol sub-feature. In this approach, the Policy Value field 355 may be divided into multiple subfields, each subfield corresponding to a predefined IDC protocol sub-feature. A bit value of 1 in a subfield indicates that a corresponding is enabled, and a bit value of 0 indicates that the policy is disabled. If multiple sub-features are advertised, the UHR element may contain a Policy Value field 355 with multiple subfields, each corresponding to a different sub-feature and organized in a fixed sequence. For example, if the AP 310 supports policies for four different sub-features, the UHR element may be structured as follows: bits 1-10 represent periodic reporting, where bit 1 corresponds to policy (i) (no constraints), bit 2 corresponds to policy (ii), and so on; bits 11-20 represent reporting of a list of multiple scheduled unavailability windows at once, where bit 11 corresponds to policy (i) (no constraints), bit 12 corresponds to policy (ii), and so on; bits 21-30 represent unsolicited reporting, where bit 21 corresponds to policy (i) (no constraints), bit 22 corresponds to policy (ii), and so on; bits 31-40 represent response-based reporting, where bit 31 corresponds to policy (i) (no constraints), bit 32 corresponds to policy (ii), and so on. In position-based encoding, the AP 310 does not explicitly signal sub-feature ID. Instead, the position of each bit 340 within the Policy Value field 355 determines the applicable sub-feature.

Through either the type-value encoding or position-based encoding, the AP (or peer STA) 310 provides a clear and structured message to connected STAs (e.g., STA 305) about the available IDC protocol sub-feature and the corresponding policies. Upon receiving the IDC policy announcement 315B, the STA 305 may evaluate its own operational requirements, network conditions, and coexistence constraints. Based on this evaluation, STA 305 may then indicate the IDC sub-feature it prefers to use (e.g., the reporting mechanism it desires) and select the corresponding policy that fits its needs. The selected sub-feature and policy may be confirmed through an acknowledgement message sent to the AP (or peer STA) 310, maintaining mutual agreement on the IDC policies between both entities. In some embodiments, the IDC policies within the announcement are mandatory. In this case, the STA 305 does not send an acknowledgement message to confirm policy selection but is instead required to comply with the announced policies as part of the association or operational procedures.

In addition to policy selection through acknowledgement, in some embodiments, STA 305 may craft its own IDC agreement that adheres to the general policies announced by AP/STA 310 but includes specific constraints or operational preferences. To initiate this agreement, STA 305 may transmit an IDC policy request to AP/STA 310, proposing customized rules for IDC mitigation. The AP/STA 310 may then evaluate the request and either accept, reject, or modify the proposed agreement based on its network policies (e.g., policies (i)-(x)) and resource management strategy. Once the agreement is reached, both devices operate under the agreed-upon terms, and enforcement actions are conducted against both the agreement and the general broadcasted policies. If no agreement is reached, STA 305 follows the general policies announced by AP/STA 310, and enforcement actions are based on these broadcasted network-wide rules (e.g., policies (i)-(x)).

FIG. 3C depicts an example IDC policy announcement 315C that includes IDC policies specific to communication links in a wireless network, according to some embodiments of the present disclosure. Unlike FIG. 3B, where IDC policies are applied to sub-features, FIG. 3C introduces a more granular policy structure, allowing different policies to be applied to different links within a multi-link operation (MLO) setup.

In a MLO setup, AP (or peer STA) 310 may connect to STA 305 through multiple links, such as one link operating on the 2.4 GHz band, one link operating on the 5 GHz band, and one link operating on the 6 GHz band. Because different frequency bands may have varying levels of congestion, interference, and coexistence constraints, IDC policies may need to be applied differently for each link. For example, policy (i) (no constraints) may only be applied to a low-speed link (e.g., 2.4 GHz) under the periodic reporting sub-feature.

To accommodate link-specific policies, type-value encoding may be used. In this approach, the UHR Operation element (for APs) or UHR Capabilities element (for STAs) (e.g., within a management frame used for announcing IDC policies) includes a Link ID field 335, a Sub-Feature field 330, and a Policy Value field 355. The Link ID field 335 may have variable length and include the link ID to indicate the specific communication link for which the IDC policies apply. In some embodiments, the Link ID field 335 may be a fixed 4-bit field, where each unique link is represented by a 4-bit identifier. In some embodiments, the Link ID field 335 may be structured as a list of 4-bit fields, allowing multiple links to be specified by concatenating separate 4-bit identifiers, each corresponding to a different link. In some embodiments, such as when handling with multi-link setups, the Link ID field 335 may be represented as an 8-bit or 16-bit bitmap, where each bit position corresponds to a specific link. In this configuration, a bit value of 1 indicates that the policy applies to the corresponding links, and a bit value of 0 indicates that the policy does not apply. The 8-bit bitmap supports up to eight links, and the 16-bit bitmap extends support to sixteen links.

The Sub-Feature field 330 may identify the IDC protocol sub-feature that the policy applies to (e.g., periodic reporting, unsolicited reporting). The Policy Value field may specify one or more IDC policies supported for the corresponding link and sub-feature. In embodiments where multiple links require different IDC policies, the UHR element may be structured to include multiple instances of these fields, each specifying a Link ID field, followed by a Sub-Feature field, followed by a Policy Value field. For example, if the AP (or peer STA) 310 wants to advertise different policies for different links, the UHR element may include the first set of fields that apply to the 2.4 GHz link, specifying policy (i) (no constraints) for periodic reporting, the second set of fields that apply to the 5 GHz link, indicating policy (iv) (restrict excessive updates) for unsolicited reporting, and the third set of fields that apply to the 6 GHz link, specifying policy (ii) (remain available on at least one link) for response-based reporting.

In another embodiment, position-based encoding may be used to advertise link-specific IDC policies. In this approach, the Link ID field 335 may still be included, as link-specific policies need explicit signaling of the applicable link. The Sub-Feature field 330 may be omitted, and instead, the position of bits 340 within the Policy Value field 355 identifies the corresponding sub-feature (e.g., a bit value of 1 indicating an enabled policy and a bit value of 0 indicating a disabled policy). For example, if AP 310 advertises different policies for three links, the UHR element may be structured to include a first Link ID field 335-1 that includes the link ID for Link 1 (e.g., 2.4 GHz), followed by a first Policy Value field 355-1 for Link 1; a second Link ID field 335-2 that includes the link ID for Link 2 (e.g., 5 GHz), followed by a second Policy Value field 355-2; a third Link ID field 335-3 that includes the link ID for Link 3 (e.g., 6 GHz), followed by a third Policy Value field 355-3. Within the first Policy Value field 355-1 (corresponding to Link 1 (2.4 GHz)), bits 1-10 to represent periodic reporting, where bit 1 corresponds to policy (i) (no constraints), bit 1 corresponds to policy (ii), and so on; bits 11-20 represent reporting of a list of multiple scheduled unavailability windows at once, where bit 11 corresponds to policy (i) (no constraints), bit 12 corresponds to policy (ii), and so on; bits 21-30 represent unsolicited reporting, where bit 21 corresponds to policy (i) (no constraints), bit 22 corresponds to policy (ii), and so on; bits 31-40 represent response-based reporting, where bit 31 corresponds to policy (i) (no constraints), bit 32 corresponds to policy (ii), and so on. In position-based encoding, the AP 310 does not explicitly signal sub-feature ID. Instead, the bit position 340 within the Policy Value field 355 determines which IDC protocol sub-feature the policy applies to.

In some embodiments, IDC policies may apply directly at the link level, without differentiating between specific sub-features. This may occur when the AP (or peer STA) enforces IDC policies uniformly across all sub-features for a given link. In this configuration, IDC policy signaling may be simplified by omitting the Sub-Feature field 330. The UHR Operation element (for APs) or UHR Capabilities element (for STAs) may include only two fields: the Link ID field 335 and the Policy Value field 355. Within the Policy Value field 355, either value-based encoding or position-based encoding may be used. In value-based encoding, policies are explicitly represented by assigned value (e.g., value 1 for policy (i)). In a position-based encoding, each bit position within the Policy Value field corresponds to a specific policy, with a bit value of 1 indicating an enabled policy and a bit value of 0 indicating a disabled policy.

In some embodiments, the depicted IDC policy announcements (or advertisements) 315A-C may be sent proactively, without first receiving an IDC mitigation request from STA 305. In this configuration, the policies are network-side instead of targeted at a specific STA. For example, the AP (or peer STA) 310 may broadcast IDC policies in a Beacon or Probe Response frame, informing all connected STAs about general IDC rules for the network.

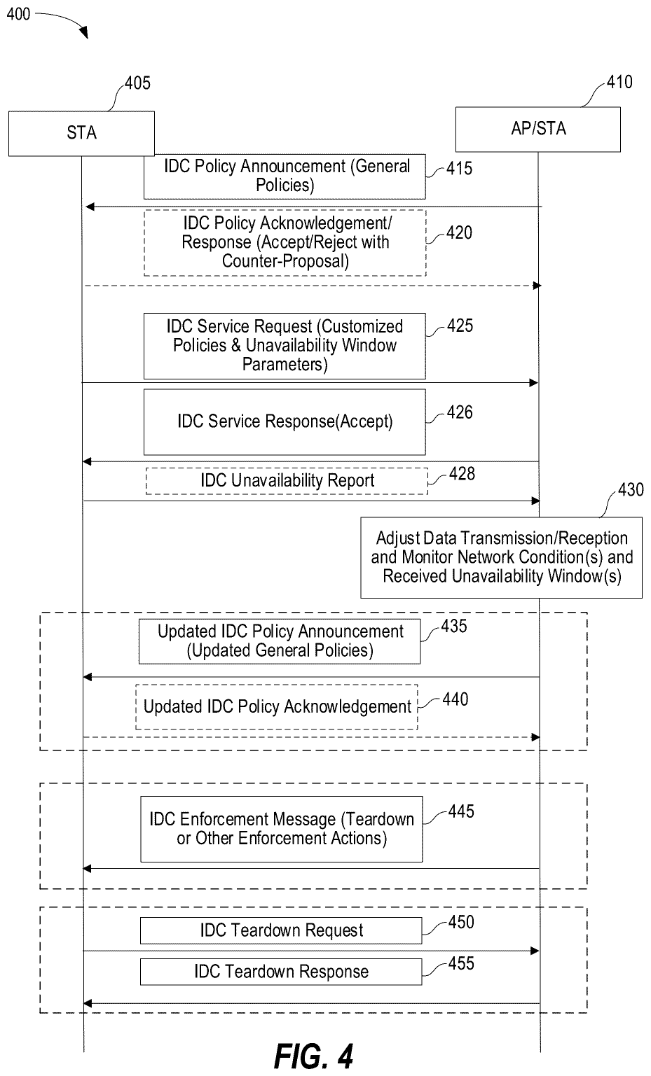

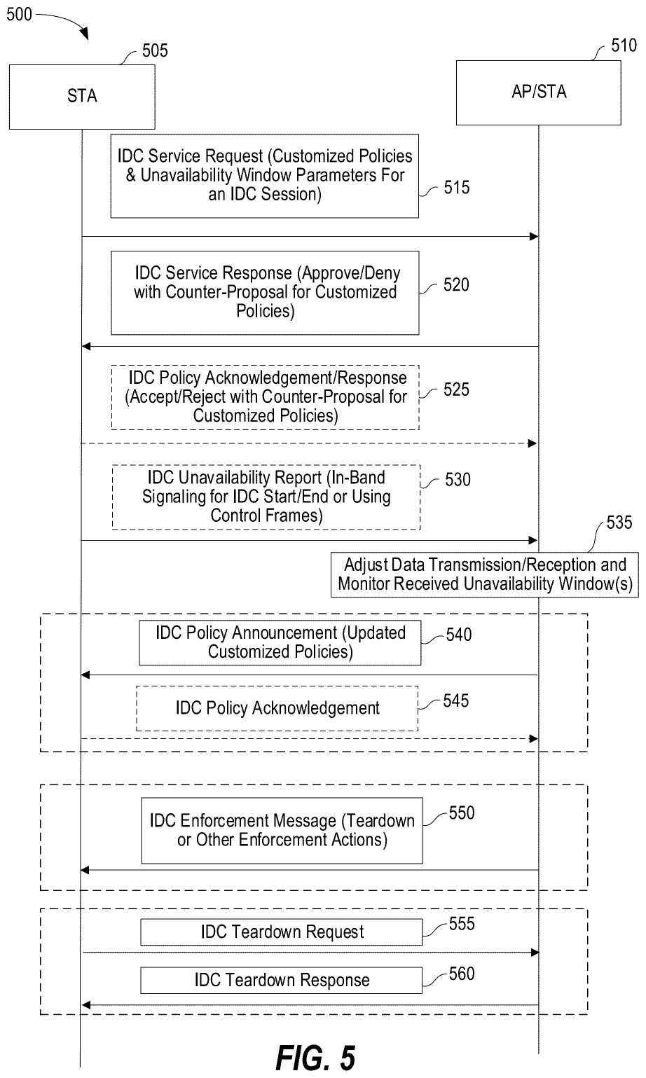

In some embodiments, STA 305 may propose customized IDC policies (or rules) in response to the broadcasted general policies 315. In this configuration, the customized policies may be more specific to the requesting STA 305, incorporating constraints or requirements adapted to STA's 305 operational needs, while remaining aligned with the general policies (e.g., policies (i)-(x)). For example, STA 305 may request IDC mitigation for a defined period, and the AP (or peer STA) 310 may evaluate the request and return an IDC policy response adapted to STA's request (e.g., adjusting unavailability reporting constraints based on the device's activity). The interactions between a requesting device and its associated AP or peer STA—including how IDC policies are exchanged, acknowledged, and enforced—are discussed below with reference to FIGS. 4 and 5.

FIG. 4 depicts an example interaction in which the associated AP or peer STA 410 proactively announces its IDC policies to the requesting STA 405, according to some embodiments of the present disclosure.

As depicted, the AP (or peer STA) 410 (which may be any device in a P2P connection) broadcasts its supported IDC policies to all connected STAs (including STA 405) proactively, without first receiving an IDC mitigation request. The STA 405 is associated with the AP or peer STA 410, and integrates multiple wireless technologies (e.g., Wi-Fi, Bluetooth, UWB) in shared hardware resources. The STA 405 needs IDC mitigation from AP/STA 410 to maintain efficient coexistence among its radios. The announcement (or advertisement) 415 (which may correspond to the announcement 315A-C as depicted in FIGS. 3A-3C) may be sent via a management frame, such as Beacon frames, Probe Response frames, or OMN frames. The announcement (or advertisement) 415 may include general ID policies (as depicted in FIG. 3A), sub-feature-specific IDC policies (as depicted in FIG. 3B), and link-specific IDC policies in MLO setup (as depicted in FIG. 3C). By proactively advertising its IDC policies, AP/STA 410 provides that all connected devices are aware of the enforced constraints before sending IDC unavailability reports.

Upon receiving the IDC policy announcement (or advertisement) 415, STA 405 evaluates its own operational needs and, optionally, sends an acknowledgement 420 to confirm the advertised policies. In embodiments where the policy announcement 415 provides multiple policies for selection, STA 405 may send an acknowledgement 420 to the AP/STA 410. The acknowledgement 420 may indicate the sub-feature STA 405 intends to use (e.g., periodic unavailability reporting, reporting of a list of scheduled unavailability windows, unsolicited reporting of an unavailability window at a time, and response-based reporting), as well as the selected policy from the multiple options provided by AP/STA 410. The acknowledgement 420 confirms the general policies (e.g., policies (i)-(x)) on how IDC mitigation will be handled.

In embodiments where the announced IDC policies are mandatory, STA 405 may directly follow these policies without sending an acknowledgement 420. In this configuration, STA 405 does not negotiate policies, but instead immediately proceeds to analyze and report unavailability windows without sending an acknowledgement.

In addition to general policy selection, STA 405 may move to negotiate more specific rules or policies with the AP/STA 410. These customized policies or rules align with the general selected policy but include detailed or specific parameters adapted to the STA's 405 needs. As depicted, STA 405 may transmit one or more IDC service requests 425 to the AP/STA 410. The IDC service request 425 may include customized requirements or proposed policies (e.g., duty cycle adjustments, channel preferences) that are specific to the operational needs of the STA 405. The request 425 may also include unavailability window parameters (e.g., start and end time, duration, or recurring intervals) to further refine the coexistence mechanism. The IDC service request 425 may be sent using a separate control frame (e.g., an IDC-specific control frame) or in-band signaling within data frames (e.g., using an IDC Control field in the MAC header). In some embodiments, the content and format of the IDC service request 425 may depend on the sub-feature used for reporting. For periodic unavailability reporting (PUO) and the reporting of a list of scheduled windows, the IDC service request 425 is sufficient to establish the unavailability windows. For example, when the periodic reporting sub-feature is used, the IDC service request 425 may indicate the recurring nature of the unavailability windows and specify the interval at which unavailability occurs along with the start and end (or duration) of each cycle. If reporting of a list of scheduled windows is used, the IDC service request 425 may include a list of predefined unavailability windows, with each entry containing a start and end time (or start time and duration).

Upon receiving the IDC service request 425, the AP/STA 410 evaluates the proposed requirements and sends an IDC service response 426 to the STA 405. The response 426 indicates whether the proposed customized requirements are accepted, partially accepted, or rejected. If accepted, the AP/STA 410 proceeds to adjust its data transmission based on the agreed-upon unavailability parameters (step 430). If rejected, the STA 405 may revise its request and resubmit it.

For dynamic reporting, such as the unsolicited reporting of one window at a time or the response-based reporting, an additional IDC unavailability report 428 (e.g., via a control frame) is needed. The report 428 includes the unavailability window parameters (e.g., start and end time, duration) and is sent dynamically by the STA 405 when a new unavailability period is anticipated or requested. As depicted, AP/STA 410 adjusts its data transmission and monitors the received IDC unavailability window(s) and network condition(s) (step 430). When changes in network conditions are detected (e.g., increased interference, changes in traffic load, or updated coexistence requirements), the AP/STA 410 may send an updated IDC policy announcement (or advertisement) 435 to STA 405. The announcement 435 indicates revised policies based on the current network conditions and device behavior. Upon receiving the updated announcement 435, the STA 405 may review the new policies and, optionally, send back an acknowledgement 440 (in negotiation scenarios) to confirm the updated policies. In some embodiments, the STA 405 may send a follow-up IDC service request with updated customized policies (which should align with the updated general policies) and unavailability parameters for subsequent windows.

AP/STA 410 also monitors the frequency and timing of unavailability reports to ensure that STA 405 follows the selected general requirements (e.g., policies (i)-(x)) as well as the agreed-upon customized policies (step 430). When a violation is detected, a policy enforcement action may be triggered. For example, policy (ii) (remain available on at least one link) may be violated if AP/STA 410 detects that STA 405 has signaled unavailability on all links simultaneously. Policy (iii) (restrict updates before a previous window ends) and policy (v) (ignore updates before a previous window ends) are violated when STA 405 attempts to modify or extend an unavailability window before the previously reported window has expired. Policy (iv) (restrict updates when exceeding a defined threshold) and policy (vi) (ignore updates when exceeding a defined threshold) are violated when STA 405 sends more unavailability window updates than allowed within a given time frame and thus exceeds the permitted update frequency. Policy (viii) (follow a maximum duty cycle limit) is violated if STA 405 exceeds the allowed percentage of time in an unavailability state within a defined interval (e.g., at most 10% of the time within a given interval). Within a Beacon interval that includes 100 time units (TU), the maximum IDC unavailability allowed is 10 TU. In this case, if STA 405 signals unavailability beyond the 10 TU limits, this would violate the duty cycle constraints, leading to possible enforcement actions. Policy (ix) (remain available in low-power listen mode on a backup link) is violated when AP/STA 410 detects that STA 405 has failed to remain in listen mode on at least one backup link while it is unavailable on a primary link. Policy (x) (restrict IDC transmissions to the AP's recommended list of channels for P2P communication) is violated when AP/STA 410 detects that STA 405 has transmitted IDC-related messages on a channel that is not included in the AP's recommended list of channels for P2P device usage. This violation may lead to interference with other network operations or failure to comply with predefined coexistence constraints set by the AP.

If a customized agreement was reached, enforcement actions may be checked against both the general policies (e.g., policies (i)-(x)) and the customized rules negotiated between the devices. In embodiments where no customized agreement was reached, enforcement actions are checked only against the general policies. In this configuration, AP/STA 410 ensures that the STA 405 follows the baseline coexistence constraints without considering any additional customized requirements.

In addition to, or instead of, violations of specific IDC policies (general or customized), the detection of prohibited behaviors that potentially impact network efficiency may also trigger a policy enforcement action. One prohibited behavior is that a client device operates in Power Save (PS) mode across all links but attempts to exploit transmission opportunities (TXOPs). For example, the client device 405 may send a PS Poll on one link to indicate that it is ready to receive data, prompting AP/STA 410 to allocate transmission resources. However, once the AP/STA 410 initiates a TXOP for data transmission, the client 405 immediately requests a shortened TXOP or fails to complete the transmission due to its PS mode status on other links. This behavior is problematic because it misuses power-saving mechanisms and disrupts the AP's scheduling. If repeated frequently, the misuse may reduce overall network efficiency, as the AP 410 may continue to schedule transmissions that the client 405 never fully utilizes.

Another prohibited behavior is inconsistent unavailability reporting in MLO. This occurs when a client 405 sends an unsolicited unavailability report to AP/STA 410, indicating that it will be unavailable on a particular link. However, during the reported unavailability window, the client 405 keeps all its other links in PS mode, making itself unavailable across the entire network without explicitly signaling full unavailability. This behavior may cause several issues. The AP/STA 410 assumes that the client 405 is unavailable only on a reported link, but in reality, the client 405 is also inactive on other links due to PS mode. This unexpected unavailability may disrupt ongoing transmission, scheduling, or coordination across multiple frequency bands. Additionally, the AP 410 may allocate resources or schedule transmissions for a link that the client is inactive, which leads to delays and wasted airtime.

When the AP/STA 410 detects a violation of the agreed-upon policies (general or customized) or any prohibited behaviors, it proceeds to take enforcement actions to maintain network stability and prevent excessive signaling overhead. As depicted, AP/STA 410 sends an IDC enforcement message 445 to STA 405. In some embodiments, the message 445 may include a teardown frame to cancel the agreed-upon IDC policies or rules (general or customized). In some embodiments, AP/STA 410 may modify STA's 405 access to a specific communication link or inform STA 405 that further communication on a particular link is disabled. In embodiments where IDC mitigation is optional, upon detecting a violation or prohibited behavior, AP/STA 410 may disable IDC mitigation functionality for STA 405 entirely (e.g., on all links), preventing it from further requesting unavailability windows. If the violation is not severe, AP/STA 410 may take a more lenient enforcement approach, allowing STA 405 to continue IDC signaling but with added restrictions. These alternative enforcement actions may include ignoring future unavailability updates from STA 405 for a defined period of time or degrading STA 405's traffic priority. By reducing STA 405's scheduling priority, AP/STA 410 ensures that STA 405 does not disrupt primary (or important) transmissions or gain unfair channel access due to improper IDC behavior.

Additionally, the STA 405 may send a teardown request 450 to the AP/STA 410 in scenarios where the STA 405 no longer requires IDC mitigation. For example, the STA 405 may send a teardown request when its coexistence constraints have been resolved (e.g., completing UWB or BT transmission), when it transitions to a different operational mode, or when it determines IDC mitigation is no longer needed. Upon receiving the teardown request 450, the AP/STA 410 sends a response 455 (accept) to the STA 405. The response finalizes the termination of the IDC agreement.

FIG. 5 depicts an example interaction 500 in which the associated AP or peer STA responds to IDC policy requests, according to some embodiments of the present disclosure. Unlike the proactive IDC policy enforcement in FIG. 4, where the AP/STA 410 broadcasts IDC policies without first receiving a request, in FIG. 5, AP/STA 510 reacts to a specific request from STA 505.

STA 505 (which may correspond to STA 105-1 as depicted in FIG. 1) operates multiple wireless technologies (e.g., Wi-Fi, Bluetooth, UWB) and transmits an IDC service request 515 to its connected AP/STA 510. The request 515 may include the STA's 505 specific requirements for reporting, such as the sub-feature it intends to use (e.g., periodic reporting, reporting of a list of scheduled windows, unsolicited reporting, or response-based reporting). Additionally, the STA 505 may craft customized policies based on its operational needs and coexistence constraints, and include the policies within the request 515.

In some embodiments, STA 505 may request that the policies be valid for a specific period of time rather than the entire association session with AP/STA 510. When periodic reporting or reporting of a list of scheduled windows is used, the request 515 may also include parameters for these windows, such as start and end times, duration, and recurring intervals. The IDC service request 515 may be transmitted using a management frame. In embodiments where IDC mitigation is optional, the request may be sent via Wireless Network Management (WNM) Channel Usage frames, UHR action frames, and OMN frames (if the network supports improved IDC negotiation). When IDC mitigation is mandatory, the request may be sent using OMN or UHR action frames.

Upon receiving the IDC service request 515, AP/STA 510 evaluates the request, including the customized policies, requested IDC session, and unavailability window parameters, against the general IDC policies (e.g., policies (i)-(x)) and current network conditions. The AP/STA 510 then sends an IDC service response 520 to STA 505. The response 520 may indicate whether the requested customized policies and IDC session are approved or rejected (e.g., via a status code). If the request is rejected, the AP/STA 510 may provide a counterproposal (e.g., a shorter IDC session duration or adjusted unavailability window parameters) along with a reason code (e.g., the requested IDC period is too long, or the AP/STA 510 cannot support IDC mitigation at the requested time due to network congestion). With the status code in the response 520, STA 505 (the requesting device) may understand the constraints and limitations of IDC mitigation before proceeding. In some embodiments, further negations for the IDC session may be performed. As used herein, the IDC session defines how long the agreed-upon policies will be enforced. This period of time is negotiated between STA 505 and AP/STA 510 and may extend over multiple unavailability windows.

Upon receiving the IDC service response 520, STA 505 reviews the response. In embodiments where IDC policy negotiation is allowed, STA 505 may send an IDC policy response/acknowledgement 525 to the AP/STA 510, either accepting the customized policies or proposing another counterproposal. In embodiments where IDC policies are mandatory, the STA 505 may not send an IDC policy response 525 but instead directly comply with the announced policies from the AP/STA 510. Upon receiving the IDC service responses 520, the STA 505 may apply the enforced policies and proceed directly to IDC unavailability reporting.

As depicted, for periodic reporting or the reporting of a list of scheduled reports, the reporting of unavailability windows is incorporated within the IDC service request 515, IDC service response 520, and optionally, IDC policy acknowledgement/response 525. For dynamic reporting, the STA 505 may send an additional IDC unavailability report 530 to the AP/STA 510, using in-band signaling (where the IDC Control field is embedded in the MAC header of a data frame) or using a separate control frame (e.g., an IDC-specific control frame).

As shown, based on the received unavailability report, AP/STA 510 adjusts its data transmission and reception to accommodate STA 505's IDC constraints (step 535). AP/STA 510 may send an IDC policy announcement (or advertisement) 540 to STA 505 when network conditions change. Within the updated announcement 540, the AP/STA 510 may indicate newly adjusted customized policies based on the current network conditions. The STA 505 may then review the new policies and, optionally, send back an acknowledgement/response 545 to confirm the updated policies. In some embodiments, the negotiation process may be bidirectional, where the STA 505 may send an updated IDC service request (similar to 515) to the AP/STA 510 when it needs to modify its IDC signaling behavior. In response, the AP/STA 510 may review the request and send a response (similar to 520), either approving the revised policies or rejecting them with a reason code.

Additionally, AP/STA 510 monitors the received unavailability reports and network conditions to detect (1) whether there are any violations of the agreed-upon customized IDC policies (e.g., exceeding the permitted update frequency, failing to follow the duty cycle limit, or modifying an unavailability window before the previously reported window has expired); and (2) whether STA 505 exhibits any prohibited behaviors (e.g., STA 505 requesting a TXOP while in PS mode and then shortening it, or STA 505 sending an unsolicited unavailability report but keeping all other links in PS mode).

When detecting a violation of the agreed-upon policies or any prohibited behavior, AP/STA 510 sends an IDC enforcement message 540 to STA 505. In some embodiments, particularly when the violation is severe (e.g., repeated violations despite prior enforcement actions, excessive updates that disrupt network performance, or STA 505 completely disregarding IDC constraints), the IDC enforcement message 540 may include a teardown frame to cancel all agreed-upon IDC policies. In embodiments where IDC mitigation is optional, AP/STA 510 may disable the IDC mitigation functionality for STA 505 (e.g., policy (vii)) entirely or on a specific communication link. In some embodiments, such as when the violation is not severe, AP/STA 510 may take more lenient enforcement actions, such as informing STA 505 that further unavailability reports will be ignored for a defined period of time, or categorizing STA 505's traffic into a low-priority queue. In some embodiments, the period for ignoring the unavailability reports from STA 505 may be adjusted based on the frequency of violations. For example, if STA 505 repeatedly violates IDC constraints, the ignore period may be extended to discourage continued violations. Conversely, if the violations become less frequent over time, the ignore period may be shortened or removed.

As depicted, the STA 505 may send a teardown request 555 to the AP/STA 510 in situations where the STA 505 no longer requires IDC mitigation (e.g., when its coexistence constraints have been resolved or when it transitions to a different operational mode). Upon receiving the teardown request 555, the AP/STA sends a response 560 (accept) to the STA 505.

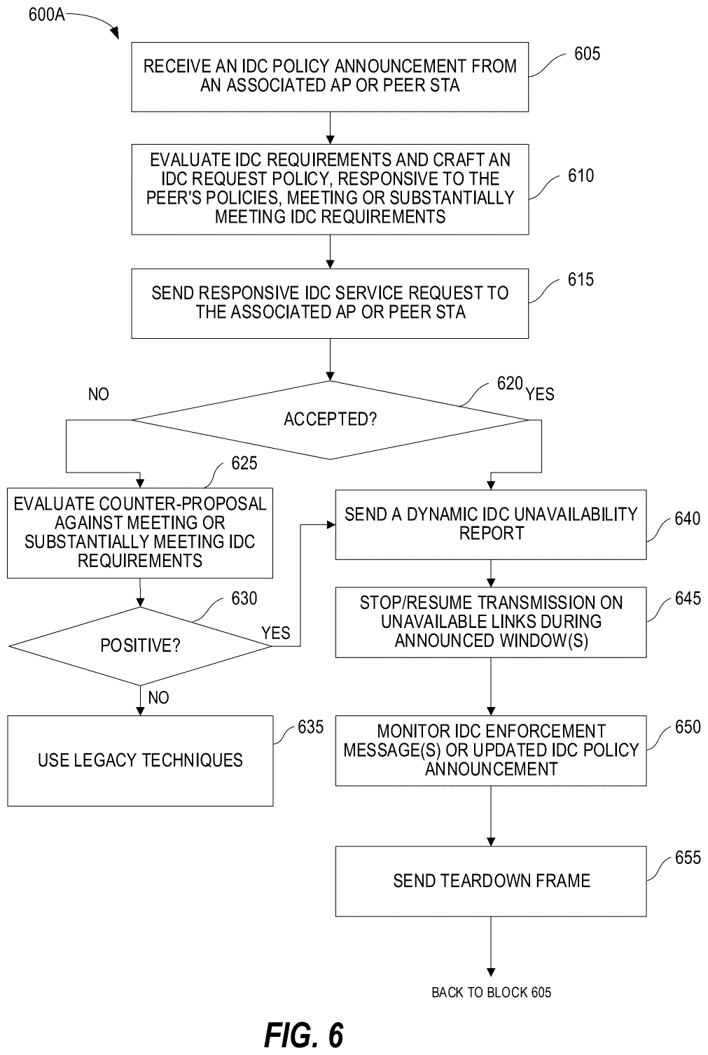

FIG. 6 depicts an example method 600 for an IDC requesting device to handle proactively announced IDC policies and report IDC unavailability windows to associated APs or peer STAs, according to some embodiments of the present disclosure. In some embodiments, the method 600A may be performed by one or more network devices, such as STA 105-1 as depicted in FIG. 1, STA 205 as depicted in FIG. 2, STA 305 as depicted in FIGS. 3A-3C, and STA 405 as depicted in FIG. 4.

At block 605, an IDC requesting device (e.g., STA 105-1 of FIG. 1 or STA 405 of FIG. 4) receives an IDC policy announcement (e.g., 415 of FIG. 4) from an associated AP (in an infrastructure network) or a peer STA (in a P2P setup). The announcement may specify general IDC policies (e.g., policies (i)-(x)), including the policies applied across different sub-features or links (as depicted in FIG. 3A), policies specific to a sub-feature (as depicted in FIG. 3B), or policies specific to a communication link (as depicted in FIG. 3C).

At block 610, the STA evaluates the announced IDC policies and its own operational requirements and coexistence constraints to generate an IDC service request (e.g., 425 of FIG. 4). The request includes customized policies that align with or substantially meet the general IDC policies while addressing the STA's specific coexistence constraints. For example, the request may specify the sub-feature the STA intends to use, and may include parameters for periodic unavailability windows reporting or reporting of a list of scheduled windows.

At block 615, the STA sends the IDC service request (e.g., 425 of FIG. 4) to the associated AP or peer STA. At block 620, the STA determines whether the customized policies in the IDC service request have been accepted by the AP or peer STA. If the request is accepted, the method 600 proceeds directly to block 640. If the request is rejected with a counterproposal, the method 600 moves to block 625.

At block 625, the STA evaluates the counterproposal from the AP or peer STA. The STA checks whether the counter-proposed policies meet or substantially meet the broadcasted general IDC requirements. If the counterproposal is acceptable, revealing positive results, the method 600 proceeds to block 640. If the counterproposal is not acceptable, the method 600 moves to block 635, where the STA may fall back to legacy techniques for coexistence management (e.g., using Power Management (PM) bit, or stopping the source of IDC), and the method ends.

At block 640, the STA sends a dynamic IDC unavailability report (e.g., 428 of FIG. 4) to the associated AP or peer STA. This operation occurs only when the agreement allows for dynamic unavailability reporting and when any periodic unavailability reports do not cover an imminent expected IDC unavailability window. If periodic reporting is sufficient to cover all unavailability windows, block 640 may be skipped. The dynamic reporting may be sent using in-band signaling (e.g., embedding the unavailability report in the MAC header of a data frame) or out-of-band signaling (e.g., using a separate control frame).

At block 645, the STA stops and/or resumes transmission on the affected communication links according to its reported unavailability windows. If a specific link is unavailable, the device may pause Wi-Fi communication link on that link while prioritizing other wireless communications (e.g., Bluetooth, UWB). Once the unavailability window expires, the device may resume Wi-Fi transmission on the affected links.

At block 650, the STA monitors for IDC enforcement messages (e.g., 445 of FIG. 4) from the AP or peer STA, and/or any updated IDC policy announcements (e.g., 435 of FIG. 4). Enforcement actions may be triggered if the STA violates the agreed-upon policies (general or customized) or exhibits prohibited behaviors (e.g., exceeding the permitted update frequency or failing to follow duty cycle limits). Updated policy announcements may reflect changes in network conditions or revised coexistence requirements.

At block 655, the STA determines that it no longer requires IDC mitigation, such as when the STA's coexistence constraints have been resolved (e.g., UWB or BT data transfer has been completed) or if the STA transitions to a different operational mode. In response, the STA sends a teardown request to the AP or peer STA. Upon receiving the teardown request, the AP or peer STA may send a response (accept) to finalize the termination of the IDC agreement. After that, the method 600 may cycle back to block 605, where the STA receives new advertised IDC policies and initiates another negotiation process.

In some embodiments, at least one of the operations at block 615 (sending an IDC service request) or block 640 (sending a dynamic IDC unavailability report), and their corresponding prerequisites (operations at blocks 605-610) may occur for the STA to report unavailability window information to the AP (or peer STA). This allows the STA and AP to establish and maintain an effective coexistence mechanism, whether through periodic reporting, dynamic reporting, or a combination of both. The operations at blocks 625-635 (evaluating counterproposals, determining policy acceptance, and falling back to legacy techniques) and blocks 645-655 (stopping/resuming transmission, monitoring for enforcement actions, and sending a teardown request) are optional and depend on the specific use case and network conditions.

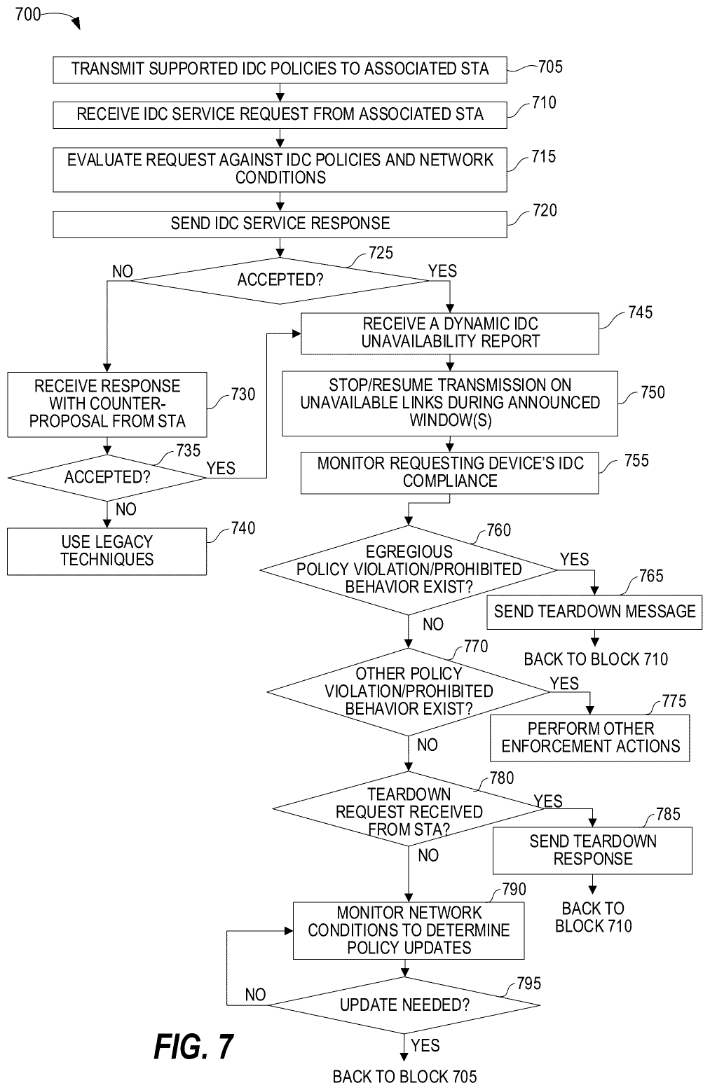

FIG. 7 depicts an example method 700 for an IDC management device to announce IDC policies proactively and enforce IDC mitigation when a violation is detected, according to some embodiments of the present disclosure. In some embodiments, the method 700 may be performed by one or more network devices, such as STA 105-2 or AP 110 as depicted in FIG. 1, AP/STA 210 as depicted in FIG. 2, AP/STA 310 as depicted in FIGS. 3A-3C, and AP/STA 410 as depicted in FIG. 4.

At block 705, an IDC management device (e.g., AP 110 of FIG. 1 or peer STA 105-2 of FIG. 1) transmits an IDC policy announcement (e.g., 415 of FIG. 4) to an associated STA (e.g., STA 105-1 of FIG. 1). The announcement includes general IDC policies (e.g., policies (i)-(x)) that the IDC management device supports. The announcement may be included in a management frame, such as Beacon frames, Probe Response frames, or OMN frames. In some embodiments, the AP may receive an acknowledgement (e.g., 420 of FIG. 4) from the associated STA. The acknowledgement confirms the IDC sub-feature the associated STA intends to use, and/or the specific IDC policy that the STA agrees to follow. In embodiments where the announced IDC policies are mandatory, the acknowledgement transmission may be skipped.

At block 710, the IDC management device receives an IDC service request (e.g., 425 of FIG. 4) from the associated STA. The request includes customized policies proposed by the STA, which align with or substantially meet the general IDC policies, as well as unavailability window information (e.g., start and end times, duration, or recurring intervals) when periodic reporting or reporting of a list of scheduled windows is used.

At block 715, the AP sends an IDC service response (e.g., 426 of FIG. 4) to the associated STA. The response indicates whether the requested customized policies are accepted or rejected with a counterproposal. If the request is accepted, as depicted at block 725, the method 700 proceeds to block 745. If the request is rejected, as depicted at block 725, the method 700 moves to block 730.

At block 730, the AP receives a response from the STA with updated policies based on the counterproposal. The updated policies are evaluated to determine whether they meet or substantially meet the general IDC requirements (e.g., policies (i)-(x)).

At block 735, the AP determines whether the updated customized policies for the associated STA are acceptable. If the updated policies are acceptable, the method 700 proceeds to block 745. If the updated policies are not acceptable, the method 700 moves to block 740, where the AP falls back to legacy requirements for coexistence management (e.g., using PM bit, or stopping the source of IDC) for a defined period of time.

At block 745, the AP receives a dynamic IDC unavailability report (e.g., 428 of FIG. 4) from the associated STA. This step is optional and occurs only when the agreement allows for dynamic reporting and when any periodic unavailability reports do not cover an imminent expected IDC unavailability window. The dynamic report may be sent using in-band signaling (e.g., embedding the unavailability report in the MAC header of a data frame) or out-of-band signaling (e.g., using a separate control frame).

At block 750, the AP adjusts its data transmission and reception based on the received unavailability windows. Specifically, the IDC management device stops transmitting data to the associated STA on the unavailability link during the reported unavailability window, and resumes transmission (e.g., by allocating TXOPs) when the unavailability window expires.

At block 755, the AP monitors the associated STA's behavior to ensure compliance with the agreed-upon IDC policies. The monitoring includes checking for violation of the agreed-upon policies (general or customized) and detecting any prohibited behaviors (e.g., inconsistent unavailability reporting or misuse of power-saving mechanisms).

At block 760, the IDC management device determines whether an egregious policy violation or prohibited behavior (e.g., repeated violations despite prior enforcement actions, excessive updates that disrupt network performance, or STA 505 completely disregarding IDC constraints) has been detected. If detected, the method 700 proceeds to block 765, where the AP sends a teardown frame to the associated STA to cancel all agreed-upon policies (general or customized) and prevent future data rescheduling. The method 700 then returns to block 710, where the AP waits for a new IDC service request to initiate a new cycle of negotiation. If no egregious violation is detected, the method 700 moves to block 770.

At block 770, the AP checks for other policy violations or prohibited behaviors. If any are detected, the method 700 proceeds to block 775, where the AP performs other enforcement actions, such as ignoring unavailability reports from the STA for a defined period of time, or reducing the STA's traffic priority to a lower category. If no violations are detected, the method 700 moves to block 780 for continuous monitoring.

At block 780, the AP monitors whether a teardown request has been received from the associated STA. If a teardown request is received, the method 700 proceeds to block 785, where the AP sends a teardown response (accept) to the STA. The response terminates the IDC agreement. If no teardown request is received, the method 700 moves to block 790 for continuous monitoring.

At block 790, the AP monitors network conditions to determine whether an IDC policy update is needed. If an update is needed, the method 700 returns to block 705, where the AP transmits an updated IDC policy announcement to the associated STA. If no updates are needed, the method 700 cycles back to block 790 to continue monitoring.

In some embodiments, the operations at blocks 755, 760, 770, 780, and 790 may be performed concurrently or sequentially by the IDC management device (e.g., AP or peer STA). In one embodiment, the AP may concurrently monitor for egregious policy violations and/or prohibited behaviors (blocks 755 and 760), check for other policy violations and/or prohibited behaviors (block 770), monitor for teardown requests (block 780), and check network conditions for policy updates (block 790). In other embodiments, these operations may be performed sequentially in any order, depending on the priority of tasks or the severity of detected issues.

In some embodiments, at least one of the operations at block 710 (receiving an IDC service request) or block 745 (receiving a dynamic IDC unavailability report) and their corresponding prerequisites (operations at blocks 705-715) may occur for the AP to receive unavailability window information from the associated STA. The operations at blocks 725-740 (evaluating counterproposals, determining policy acceptance, and falling back to legacy techniques) and blocks 750-795 (adjusting data transmission, monitoring for policy violations, performing enforcement actions, and monitoring for teardown requests or policy updates) are optional and depend on the specific use case and network conditions.

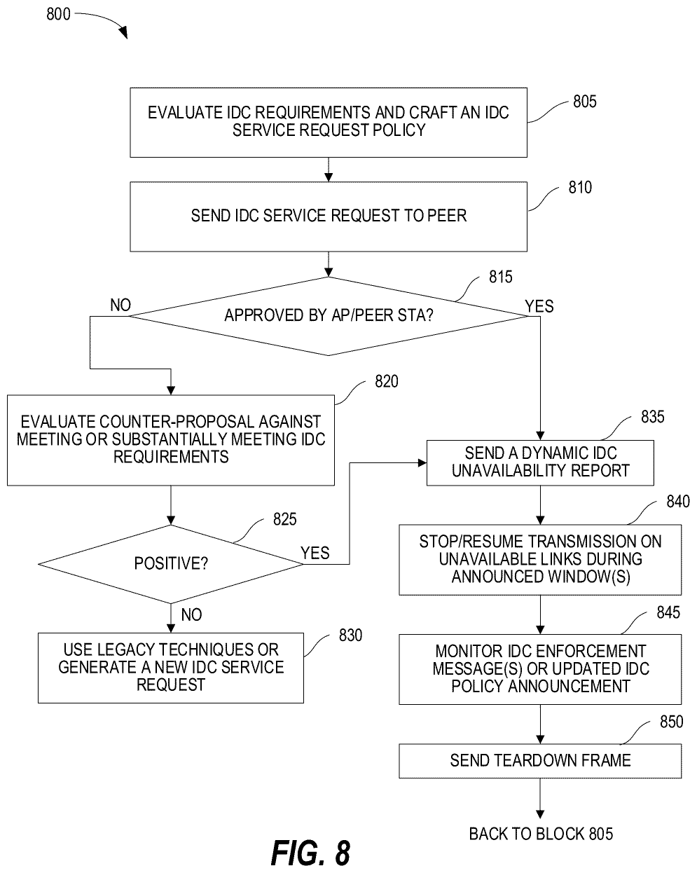

FIG. 8 depicts an example method 800 for an IDC requesting device to negotiate customized IDC policies and manage coexistence with associated APs or peer STAs, according to some embodiments of the present disclosure. In some embodiments, the method 700A may be performed by one or more network devices, such as STA 105-1 as depicted in FIG. 1, STA 205 as depicted in FIG. 2, STA 305 as depicted in FIGS. 3A-3C, and STA 505 as depicted in FIG. 5.

At block 805, an IDC requesting device (e.g., STA 105-1 of FIG. 1 or STA 505 of FIG. 5) evaluates its internal operating conditions and IDC requirements to determine the need for IDC mitigation. The STA generates an IDC service request (e.g., 515 of FIG. 5) that includes its IDC requirements, such as the sub-feature reporting mechanism it intends to use (e.g., periodic reporting, reporting of a list of scheduled windows, unsolicited reporting, or response-based reporting), the IDC session it requests (e.g., the duration for which IDC mitigation is needed), and customized policies that align with its operational needs. The request may also include unavailability window parameters (e.g., start and end times, duration, or recurring intervals) for periodic reporting.

At block 810, the STA sends the IDC service request to its associated AP (if operating in an infrastructure network) or to a peer STA (if in a P2P setup). The IDC service request may be sent using a management frame, such as WNM Channel Usage frames, UHR action frames, or OMN frames. The AP (or peer STA) reviews the IDC session, proposed customized policies, and unavailability window parameters in the request to determine whether they align with the available general IDC policies and network conditions. Based on this evaluation, the AP or peer STA either approves the request, or rejects it, providing a counterproposal with adjusted policies or session parameters.

At block 815, the STA receives an IDC service response (e.g., 520 of FIG. 5) from the AP or peer STA. The response indicates whether the requested customized policies and IDC session are approved or rejected with a counterproposal. If the request is accepted, the method moves to block 835. If the request is rejected, the method 800 moves to block 820.

At block 820, the STA evaluates the counterproposal from the AP or peer STA to determine whether the proposal can be accepted, considering its configuration, network demands, and operational constraints. If the counterproposal is acceptable, revealing positive results, the method 800 moves to block 835. If the counterproposal is not acceptable, the method 800 moves to block 830. In some embodiments, the STA may optionally send an acknowledgement/response (e.g., 525 of FIG. 5) back to the AP to confirm the acceptance or provide a new proposal.

At block 830, the STA either falls back to legacy techniques for coexistence management (e.g., using PM bit, or stopping the source of IDC) or generates a new IDC service request to restart the negotiation process. If a new request is generated, the method 800 returns to block 810.

At block 835, the STA sends a dynamic IDC unavailability report (e.g., 530 of FIG. 5) to the AP or peer STA. This operation is optional and occurs only when the agreed-upon policies allow for dynamic reporting and when any periodic unavailability reports do not cover an imminent expected IDC unavailability window. The report may be transmitted using in-band signaling or a separate control frame.

At block 840, the STA stops and/or resumes transmission on the affected communication links according to its reported unavailability windows. For example, in MLO setup, the STA may pause communication on specific frequency bands (e.g., 2.4 GHz) while maintaining activity on others (e.g., 5 GHz or 6 GHz).

At block 845, the IDC requesting device monitors for IDC enforcement messages (e.g., 540 of FIG. 5) or updated IDC policy announcements (e.g., 550 of FIG. 5) from the AP or peer STA. Enforcement actions may be triggered if the STA violates the agreed-upon policies or exhibits prohibited behaviors. Updated policy announcements may reflect changes in the network conditions or updated coexistence requirements.

At block 850, the STA determines whether it no longer requires coexistence support from the AP or peer STA or whether the requested IDC session has expired. If either condition is met, the STA sends a teardown frame to the AP or peer STA to terminate the IDC agreement. The method 800 may then return to block 805, where the STA can evaluate its IDC requirements and initiate a new negotiation process if needed.

In some embodiments, either of the operations at block 810 (sending an IDC service request) or block 935 (sending a dynamic IDC unavailability report), along with their corresponding prerequisites (block 805 for generating the IDC service request), may occur for the STA to communicate unavailability window information to the AP or peer STA. The operations at blocks 815-830 (evaluating counterproposals, accepting or rejecting customized policies, and falling back to legacy techniques) and blocks 840-850 (stopping/resuming transmission, monitoring for enforcement actions, and sending a teardown request) are optional and depend on specific use cases and network conditions.

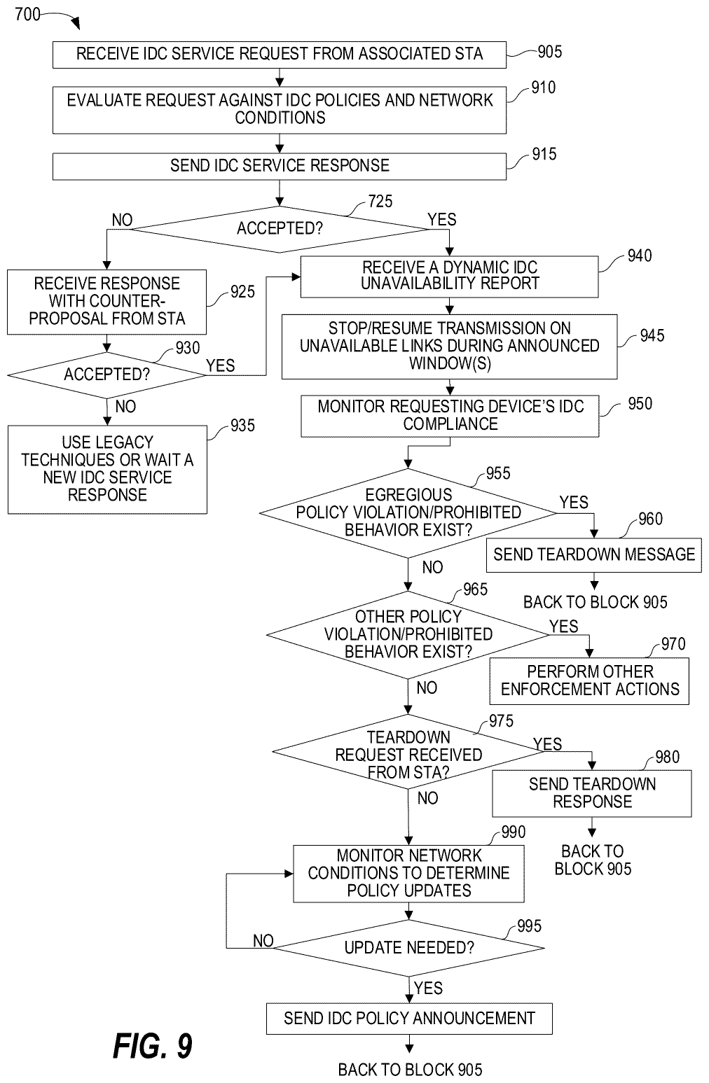

FIG. 9 depicts an example method 900 for an IDC management device to negotiate customized IDC policies and manage coexistence with associated STAs, according to some embodiments of the present disclosure. In some embodiments, the method 700B may be performed by one or more network devices, such as STA 105-2 or AP 110 as depicted in FIG. 1, AP/STA 210 as depicted in FIG. 2, AP/STA 310 as depicted in FIGS. 3A-3C, and AP/STA 510 as depicted in FIG. 5.

At block 905, an IDC management device (e.g., AP 110 of FIG. 1 or STA 105-2 of FIG. 1, or AP/STA 510 of FIG. 5) receives an IDC service request (e.g., 515 of FIG. 5) from an associated STA (e.g., STA 505 of FIG. 5). The request may include the STA's IDC requirements, such as the sub-feature reporting mechanism it prefers (e.g., periodic reporting, reporting of a list of scheduled windows, unsolicited reporting, or response-based reporting), customized policies proposed by the STA, and the IDC session requested (e.g., the duration for which the policies should be valid). For periodic reporting, the request may also include the unavailability window parameters (e.g., start and end times, duration, or recurring intervals).

At block 910, the AP evaluates the IDC service request against the general IDC policies and current network conditions. The evaluation is performed to ensure that the proposed customized policies and IDC sessions are feasible and do not conflict with the general IDC policies (e.g., policies (i)-(x)) or network constraints.

At block 915, the AP sends an IDC service response (e.g., 520 of FIG. 5) to the associated STA. The response indicates whether the requested customized policies and IDC session are approved or rejected with a counterproposal. If the request is accepted, as depicted at block 920, the method 900 moves to block 940. If the request is rejected, as depicted at block 920, the method 900 moves to block 925.

At block 925, the AP receives an additional response/acknowledgement (e.g., 525 of FIG. 5) from the STA, indicating whether the counterproposal has been accepted or if the STA has proposed a new set of customized policies. The operation is optional and occurs when IDC policy negotiation is allowed. In mandatory scenarios, the STA directly follows the revised policies without sending an additional response.

At block 930, the AP determines whether the new proposal from the STA is acceptable. If the counterproposal is accepted, the method 900 moves to block 940, where the agreement is finalized. If the counterproposal is not acceptable, the method 900 moves to block 935, where the AP either falls back to legacy techniques for coexistence management (e.g., using PM bit, or stopping the source of IDC) or waits for a new IDC service request from the STA.

At block 940, the AP receives a dynamic IDC unavailability report from the associated STA. The operation is optional and occurs only when the agreement allows for dynamic reporting and when any periodic unavailability reports do not cover an imminent expected IDC unavailability window. The dynamic report may be sent using in-band signaling or out-of-band signaling (e.g., using a separate control frame).

At block 945, the AP adjusts its data transmission to comply with the associated STA's reported unavailability windows. The AP stops transmission to the associated STA on unavailable links during the reported unavailability windows, and resumes normal operations when the unavailability window expires. In MLO setups, the IDC management device may reallocate data transmissions (e.g., TXOPs) to available links while one or more links are unavailable.

At block 950, the AP monitors the associated STA's behavior to ensure compliance with the agreed-upon policies. In some embodiments, enforcement actions may be triggered either by direct violation of policies (e.g., exceeding permitted update frequency, violating duty cycle limits, or modifying windows before a previous window expires) or by exhibiting prohibited behaviors (e.g., an STA requesting a TXOP in PS mode and then shortening the TXOP, or an STA sending an unsolicited unavailability report while keeping all other links in PS mode). At block 955, the AP determines whether an egregious policy violation or prohibited behavior (e.g., repeated violations despite prior enforcement actions, excessive updates that disrupt network performance, or STA 505 completely disregarding IDC constraints) has been detected. If yes, the method 900 moves to block 960, where the AP sends a teardown frame to the associated STA to cancel all agreed-upon policies. The method 900 then returns to block 905 to await a new IDC service request. If no egregious violation or behavior is detected, the method 900 proceeds to block 965.

At block 965, the AP checks for other policy violations or prohibited behaviors. If any are detected, the method 900 moves to block 970, where the AP performs other enforcement actions, such as ignoring unavailability reports from the STA for a defined period of time or reducing the STA's traffic priority to a lower category. If no violations are detected, the method 900 then proceeds to block 975 for continuous monitoring.

At block 975, the AP checks for a teardown message from the STA. If a teardown message is received, the method proceeds to block 980, where the AP sends a response (accept) to the STA to terminate the IDC agreement. The method 900 then returns to block 905 to await a new IDC service request. If no violations are detected, the method moves to block 985.

At block 985, the AP monitors network conditions to determine whether an IDC policy update is needed. If an update is needed, as indicated at block 990, the method 900 moves to block 995, where the AP sends an updated IDC policy announcement (e.g., 540 of FIG. 5) to the associated STAs. The method 900 then cycles back to block 905, where the AP receives a new IDC service request with updated customized policies from the STA. If no updates are needed, the method 900 cycles back to block 985 to continue monitoring.

In some embodiments, the operations at blocks 950, 955, 965, 975, and 985 may be performed concurrently or sequentially by the IDC management device (e.g., AP or peer STA). In one embodiment, the AP may concurrently monitor for egregious policy violations and/or prohibited behaviors (blocks 950 and 955), check for other policy violations and/or prohibited behaviors (block 965), monitor for teardown requests (block 975), and check network conditions for policy updates (block 985). In other embodiments, these operations may be performed sequentially in any order, depending on the priority of tasks or the severity of detected issues.

In some embodiments, at least one of the operations at block 905 (receiving an IDC service request) or block 940 (receiving a dynamic IDC unavailability report) and their corresponding prerequisites (operations at blocks 910-915) may occur for the AP to receiving unavailability window information from the associated STA. The operations at blocks 925-935 (evaluating counterproposals, determining policy acceptance, and falling back to legacy techniques) and blocks 945-995 (adjusting data transmission, monitoring for policy violations, performing enforcement actions, and monitoring for teardown requests or policy updates) are optional and depend on the specific use case and network conditions.

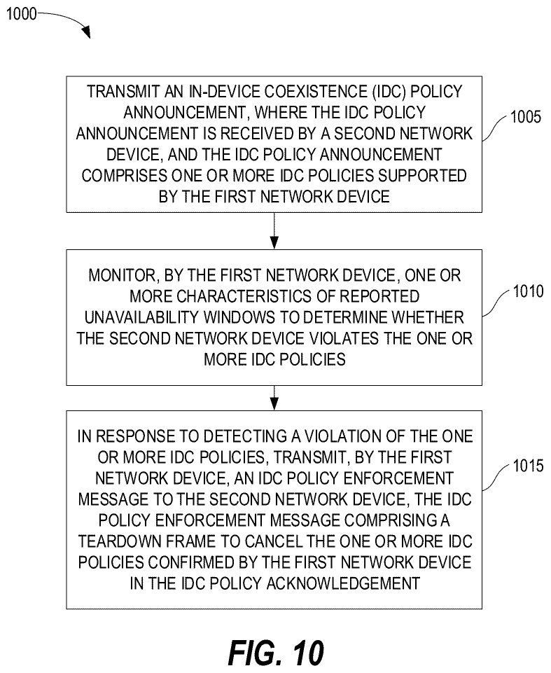

FIG. 10 is a flow diagram depicting an example method 1000 for IDC policy announcement and policy compliance monitoring, according to some embodiments of the present disclosure.

At block 1005, a first network device (e.g., AP/STA 210 of FIG. 2) transmits an in-device coexistence (IDC) policy announcement, where the IDC policy announcement is received by a second network device (e.g., STA 205 of FIG. 2), and the IDC policy announcement (e.g., 315A-C of FIGS. 3A-3C) comprises one or more IDC policies supported by the first network device.

At block 1010, the first network device monitors one or more characteristics of reported unavailability windows to determine whether the second network device violates the one or more IDC policies.

At block 1015, in response to detecting a violation of the one or more IDC policies, the first network device transmits an IDC policy enforcement message (e.g., 445 of FIG. 4, 540 of FIG. 5) to the second network device, the IDC policy enforcement message comprising a teardown frame to cancel the one or more IDC policies confirmed by the first network device.

In some embodiments, the first network device may receive an IDC policy acknowledgement (e.g., 420 of FIG. 4, 525 of FIG. 5) from the second network device, the IDC policy acknowledgement confirming acceptance of at least one of the one or more IDC policies by the second network device.

In some embodiments, the first network device may receive one or more IDC unavailability reports from the second network device, at least one of the one or more IDC unavailability reports comprising the one or more reported unavailability windows.

In some embodiments, the first network device may comprise an access point (AP) (e.g., 110 of FIG. 1) or a non-access point (AP) station (STA) (e.g., 105-2 of FIG. 1), and the second network device may comprise a non-AP STA (e.g., 105-1 of FIG. 1), and the first network device connects to the second network device via one or more communication links.

In some embodiment, the one or more IDC policies in the IDC policy announcement may comprise at least one of: (i) a policy where no constraints are placed on unavailability signaling by the second network device; (ii) a policy where the second network device remains available on a second link while a first link is unavailable; (iii) a policy where the first network device restricts the second network device from sending an unavailability update before a previously signaled unavailability window has ended; (iv) a policy where the first network device restricts the second network device from sending an unavailability update if detecting that a frequency of receiving unavailability updates exceeds a frequency threshold; (v) a policy where the first network device ignores an unavailability update from the second network device if a frequency of receiving unavailability updates exceeds a frequency threshold; (vi) a policy where the first network device ignores an unavailability update from the second network device if a previously signaled unavailability window has not ended; (vii) a policy where the first network device disables a function of providing IDC mitigation to the second network device; (viii) a policy where a maximum duty cycle for IDC unavailability reporting is established for the second network device; (ix) a policy where the second network device remains available in a low-power listen mode on a backup link while a first link is unavailable; or (x) a policy where IDC transmissions from or to the second network device are restricted to channels that conform to a recommended list of channels for IDC operation, as provided by the first network device.

In some embodiments, the maximum duty cycle for IDC unavailability may be adjusted based on network congestion and traffic demands.

In some embodiments, the IDC policy announcement may further comprise an IDC protocol sub-feature implemented by the first network device, the IDC protocol sub-feature comprising support for at least one of periodic unavailability windows, a list of scheduled unavailability windows, an unsolicited report of a single unavailability window, or a response indicating an upcoming unavailability window in response to a control frame.

In some embodiments, two or more IDC policies may be applied along with the IDC protocol sub-feature on one or more links between the first and second network devices.

In some embodiments, the IDC policy announcement may be transmitted by the first network device in response to receiving a request for IDC mitigation (e.g., 515 of FIG. 5) from the second network device.

In some embodiments, the request may comprise at least one of a single defined period of time or a sequence of defined periods of time requested by the first network device for IDC mitigation, and the IDC policy announcement may comprise the one or more IDC policies and a status code indicating whether the defined period of time for IDC mitigation is accepted or denied by the first network device.

In some embodiments, the IDC policy announcement may be transmitted proactively by the first network device without receiving a request for IDC mitigation from the second network device.

In some embodiments, the IDC policy announcement may comprise a management frame, and the management frame is at least one of a beacon frame, a probe response frame, an association request frame, an association response frame, a reassociation request frame, a reassociation response frame, or an operating mode notification (OMN) frame.

In some embodiments, the management frame may comprise a policy value field configured to represent each of the one or more IDC policies by a respective value.

In some embodiments, the management frame comprises a sub-feature identifier (ID) field configured to indicate an IDC protocol sub-feature, and a policy value field configured to represent one or more IDC policies associated with the IDC protocol sub-feature.

In some embodiments, the management frame may comprise a policy value field, the policy value field comprising a plurality of subfields, each subfield corresponding to a predefined IDC protocol sub-feature based on a position within the policy value field.

In some embodiments, each subfield may comprise one or more bits, where a first bit value indicates that a corresponding IDC policy is enabled, and a second bit value indicates that the corresponding IDC policy is disabled.

In some embodiments, the management frame may comprise a link identifier (ID) field configured to identify a communication link between the first and second network devices, a sub-feature identifier (ID) field configured to indicate an IDC protocol sub-feature, and a policy value field configured to represent one or more IDC policies associated with the IDC protocol sub-feature on the communication link.

In some embodiments, the management frame may comprise a link identifier (ID) field configured to identify a communication link between the first and second network devices, and a policy value field, the policy value field comprising a plurality of subfields, each subfield corresponding to a predefined IDC protocol sub-feature based on a position within the policy value field, where each subfield comprises one or more bits, and a first bit value indicates that a corresponding IDC policy for the communication link is enabled, and a second bit value indicates that the corresponding IDC policy for the communication link is disabled.

In some embodiments, the first network device may transmit an updated IDC policy announcement to the second network device, the updated IDC policy announcement comprising one or more revised IDC policies supported by the first network device.

In some embodiments, in response to detecting a violation of the one or more IDC policies, the first network device may perform at least one of disabling a function of providing IDC mitigation to the second network device, disregarding IDC unavailability reports from the second network device for a defined period of time, reducing a traffic priority of the second network device; disabling access to a communication link, or indicating to the second network device that further communication on the communication link is disabled.

In some embodiments, the period of time for disregarding IDC unavailability reports may be determined based on a frequency of violations by the second network device.

In some embodiments, detecting the violation of the one or more IDS policies comprises at least one of detecting that a frequency of receiving IDC unavailability reports from the second network device exceeds a defined threshold, detecting that the second network device transmits data during a previously reported IDC unavailability window, detecting that the second network device fails to remain available on a second link while a first link is unavailable, detecting that the second network device sends an IDC unavailability update before a previously signaled unavailability window has ended, detecting that the second network device fails to maintain available in a low-power listen mode on a backup link during an IDC unavailability window, detecting that the second network device enters a low-power listen mode on all links between the first and second network devices while reporting IDC unavailability; detecting that the second network device exceeds a maximum duty cycle for IDC unavailability within a defined time interval, or detecting that the second network device transmitting on a channel not recommended for IDC operation by the first network device.

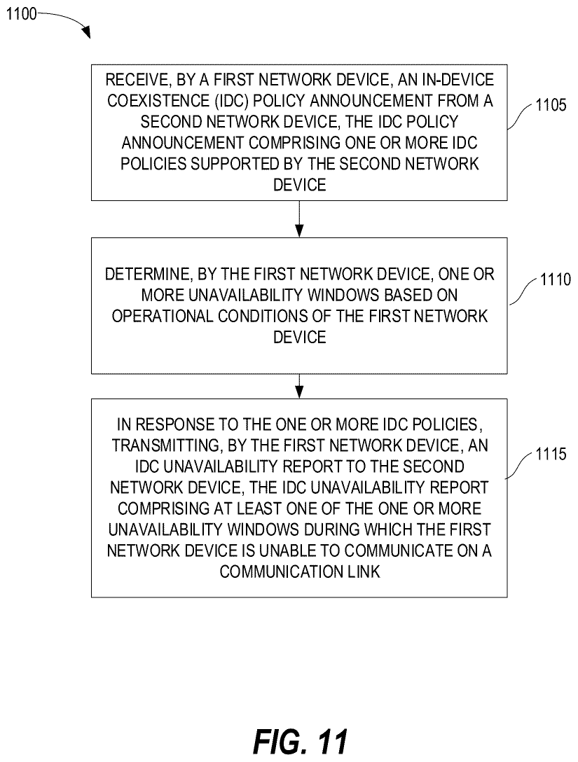

FIG. 11 is a flow diagram depicting an example method 1100 for IDC policy selection and unavailability reporting, according to some embodiments of the present disclosure.

At block 1105, the first network device (e.g., 105-1 of FIG. 1) receives an in-device coexistence (IDC) service request (e.g., 515 of FIG. 5) from a second network device (e.g., 105-2 of FIG. 1 or 110 of FIG. 1), the IDC service request comprising one or more IDC policies supported by the second network device.

At block 1110, the first network device determines one or more unavailability windows based on operational conditions of the first network device.

At block 1115, in response to the one or more IDC policies, the first network device transmits an IDC unavailability report (e.g., 425 of FIG. 4, 530 of FIG. 5) to the second network device, the IDC unavailability report comprising at least one of the one or more unavailability windows during which the first network device is unable to communicate on a communication link.

In some embodiments, the first network device may further monitor for an IDC enforcement message (e.g., 435 of FIG. 4, 540 of FIG. 5) from the second network device, the IDC policy enforcement message indicating a violation of the one or more IDC policies by the first network device. In response to receiving the IDC policy enforcement message, the first network device may further adjust subsequent unavailability reporting to comply with the one or more IDC policies, or revert to legacy behaviors, comprising using a power management (PM) bit or stopping the source of IDC, for a defined period of time.

In some embodiments, the first network device may comprise a non-access point (AP) station (STA) (e.g., 105-2 of FIG. 1), and the second network device may comprise an access point (AP) (e.g., 110 of FIG. 1) or a non-AP STA (e.g., 105-1 of FIG. 1), and the first network device may connect to the second network device via one or more communication links.

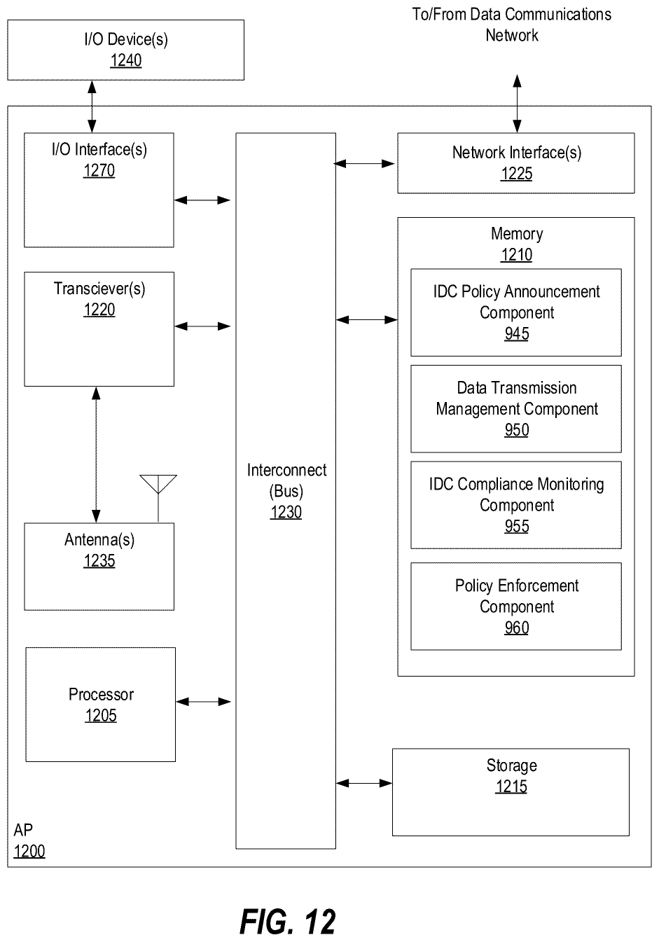

FIG. 12 depicts an example network device 1200 configured to perform various aspects of the present disclosure, according to some aspects of the present disclosure. In some embodiments, the example network device 1200 may be an AP or an STA, and provide IDC mitigation support for an associated STA (e.g., which is a device that operates multiple wireless technologies on shared hardware). In some embodiments, the example network device 1000 may correspond to AP 110 or STA 105-2 as depicted in FIG. 1, AP/STA 210 as depicted in FIG. 2, AP/STA 310 as depicted in FIGS. 3A-3C, AP/STA 410 as depicted in FIG. 4, and AP/STA 510 as depicted in FIG. 5.

As illustrated, the example network device 1200 includes a processor 1205, memory 1210, storage 1215, one or more transceivers 1220, one or more I/O interfaces 1280, and one or more network interfaces 1225. In some embodiments, I/O devices 1240 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. In the illustrated example, the memory 1210 includes four software components: the IDC policy announcement component 1245, the data transmission management component 1250, the IDC compliance monitoring component 1255, and the policy enforcement component 1260.

In one embodiment, the IDC policy announcement component 1245 manages proactive and/or reactive IDC policy advertisements, including general IDC policies, sub-feature-specific policies, and link-specific policies. The IDC policy announcement component 1245 encodes policies in management frames and processes acknowledgements from STAs confirming agreed-upon policies.

In one embodiment, the data transmission management component 1250 manages data transmission based on IDC unavailability reports, such as stopping transmission on unavailability links and resuming transmission when the unavailability window expires. In MLO setup, the data transmission management component 1250 may allocate resources over availability frequency bands while one or more bands are unavailable.

In one embodiment, the IDC compliance monitoring component 1255 processes received IDC unavailability reports and monitors the reporting STA's behavior to ensure compliance with agreed-upon policies. Specifically, the IDC compliance monitoring component 1255 tracks unavailability updates to detect policy violations, monitors network conditions and other relevant parameters to detect prohibited behaviors, and logs compliance data for adaptive enforcement strategies.

In one embodiment, the policy enforcement component 1260 handles enforcement actions when policy violations or prohibited behaviors are detected.

Examples of enforcement actions include sending a teardown frame to revoke IDC policies, disabling IDC mitigation entirely for an STA, ignoring future unavailability updates from an STA for a defined period, or reducing STA's traffic priority to a lower category.

The policy enforcement component 1260 also adjusts policies dynamically based on network conditions, compliance history, and interference levels.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments.

Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or severe. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting, from a first network device, an in-device coexistence (IDC) policy announcement, wherein the IDC policy announcement is received by a second network device, and the IDC policy announcement comprises one or more IDC policies supported by the first network device;
monitoring, by the first network device, one or more characteristics of reported unavailability windows to determine whether the second network device violates the one or more IDC policies; and
in response to detecting a violation of the one or more IDC policies, transmitting, by the first network device, an IDC policy enforcement message to the second network device, the IDC policy enforcement message comprising a teardown frame to cancel the one or more IDC policies confirmed by the first network device.

2. The method of claim 1, further comprising:
receiving, by the first network device, an IDC policy acknowledgement from the second network device, the IDC policy acknowledgement confirming acceptance of at least one of the one or more IDC policies by the second network device.

3. The method of claim 1, further comprising:
receiving, by the first network device, one or more IDC unavailability reports from the second network device, at least one of the one or more IDC unavailability reports comprising the reported unavailability windows.

4. The method of claim 1, wherein the first network device comprises an access point (AP) or a non-access point (AP) station (STA), the second network device comprises a non-AP STA, and the first network device connects to the second network device via one or more communication links.

5. The method of claim 1, wherein the one or more IDC policies in the IDC policy announcement comprises at least one of:
(i) a policy where no constraints are placed on unavailability signaling by the second network device;
(ii) a policy where the second network device remains available on a second link while a first link is unavailable;
(iii) a policy where the first network device restricts the second network device from sending an unavailability update before a previously signaled unavailability window has ended;
(iv) a policy where the first network device restricts the second network device from sending an unavailability update if detecting that a frequency of receiving unavailability updates exceeds a frequency threshold;
(v) a policy where the first network device ignores an unavailability update from the second network device if a frequency of receiving unavailability updates exceeds a frequency threshold;
(vi) a policy where the first network device ignores an unavailability update from the second network device if a previously signaled unavailability window has not ended;
(vii) a policy where the first network device disables a function of providing IDC mitigation to the second network device;
(viii) a policy where a maximum duty cycle for IDC unavailability reporting is established for the second network device;
(ix) a policy where the second network device remains available in a low-power listen mode on a backup link while a first link is unavailable; or
(x) a policy where IDC transmissions from or to the second network device are restricted to channels that conform to a recommended list of channels for IDC operation, as provided by the first network device.

6. The method of claim 5, wherein the maximum duty cycle for IDC unavailability is adjusted based on network congestion and traffic demands.

7. The method of claim 1, wherein the IDC policy announcement further comprises an IDC protocol sub-feature implemented by the first network device, the IDC protocol sub-feature comprising support for at least one of:
periodic unavailability windows;
a list of scheduled unavailability windows;
an unsolicited report of a single unavailability window; or
a response indicating an upcoming unavailability window in response to a control frame.

8. The method of claim 7, wherein two or more IDC policies are applied along with the IDC protocol sub-feature on one or more links between the first and second network devices.

9. The method of claim 1, wherein the IDC policy announcement is transmitted by the first network device in response to receiving a request for IDC mitigation from the second network device.

10. The method of claim 9, wherein the request comprises at least one of a single defined period of time or a sequence of defined periods of time requested by the first network device for IDC mitigation, and the IDC policy announcement comprises the one or more IDC policies and a status code indicating whether the defined period of time for IDC mitigation is accepted or denied by the first network device.

11. The method of claim 1, wherein the IDC policy announcement is transmitted proactively by the first network device without receiving a request for IDC mitigation from the second network device.

12. The method of claim 1, wherein the IDC policy announcement comprises a management frame, and the management frame is at least one of:
a beacon frame;
a probe response frame;
an association request frame;
an association response frame;
a reassociation request frame;
a reassociation response frame; or
an operating mode notification (OMN) frame.

13. The method of claim 12, wherein the management frame comprises a policy value field configured to represent each of the one or more IDC policies by a respective value.

14. The method of claim 12, wherein the management frame comprises:
a sub-feature identifier (ID) field configured to indicate an IDC protocol sub-feature, and
a policy value field configured to represent one or more IDC policies associated with the IDC protocol sub-feature.

15. The method of claim 12, wherein:
the management frame comprises a policy value field, the policy value field comprising a plurality of subfields, each subfield corresponding to a predefined IDC protocol sub-feature based on a position within the policy value field,
each subfield comprises one or more bits, and
a first bit value indicates that a corresponding IDC policy is enabled, and a second bit value indicates that the corresponding IDC policy is disabled.

16. The method of claim 12, wherein the management frame comprises:
a link identifier (ID) field configured to identify a communication link between the first and second network devices,
a sub-feature identifier (ID) field configured to indicate an IDC protocol sub-feature, and
a policy value field configured to represent one or more IDC policies associated with the IDC protocol sub-feature on the communication link.

17. The method of claim 12, wherein the management frame comprises:
a link identifier (ID) field configured to identify a communication link between the first and second network devices; and
a policy value field, the policy value field comprising a plurality of subfields, each subfield corresponding to a predefined IDC protocol sub-feature based on a position within the policy value field, wherein:
each subfield comprises one or more bits, and
a first bit value indicates that a corresponding IDC policy for the communication link is enabled, and a second bit value indicates that the corresponding IDC policy for the communication link is disabled.

18. The method of claim 1, further comprising:
transmitting, by the first network device, an updated IDC policy announcement to the second network device, the updated IDC policy announcement comprising one or more revised IDC policies supported by the first network device.

19. The method of claim 1, further comprising:
in response to detecting a violation of the one or more IDC policies, performing, by the first network device, at least one of:
disabling a function of providing IDC mitigation to the second network device;
disregarding IDC unavailability reports from the second network device for a defined period of time;
reducing a traffic priority of the second network device;
disabling access to a communication link; or
indicating to the second network device that further communication on the communication link is disabled.

20. The method of claim 19, wherein the defined period of time for disregarding IDC unavailability reports is determined based on a frequency of violations by the second network device.

21. The method of claim 1, wherein detecting the violation of the one or more IDS policies comprises at least one of:
detecting that a frequency of receiving IDC unavailability reports from the second network device exceeds a defined threshold;
detecting that the second network device transmits data during a previously reported IDC unavailability window;
detecting that the second network device fails to remain available on a second link while a first link is unavailable;
detecting that the second network device sends an IDC unavailability update before a previously signaled unavailability window has ended;
detecting that the second network device fails to maintain available in a low-power listen mode on a backup link during an IDC unavailability window;
detecting that the second network device enters a low-power listen mode on all links between the first and second network devices while reporting IDC unavailability;
detecting that the second network device exceeds a maximum duty cycle for IDC unavailability within a defined time interval; or
detecting that the second network device transmitting on a channel not recommended for IDC operation by the first network device.

22. A method, comprising:
receiving, by a first network device, an in-device coexistence (IDC) service request from a second network device, the IDC service request comprising one or more IDC policies supported by the second network device;
determining, by the first network device, one or more unavailability windows based on operational conditions of the first network device; and
in response to the one or more IDC policies, transmitting, by the first network device, an IDC unavailability report to the second network device, the IDC unavailability report comprising at least one of the one or more unavailability windows during which the first network device is unable to communicate on a communication link.

23. The method of claim 22, further comprising:
monitoring, by the first network device, for an IDC enforcement message from the second network device, the IDC enforcement message indicating a violation of the one or more IDC policies by the first network device; and
in response to receiving the IDC enforcement message:
adjusting, by the first network device, subsequent unavailability reporting to comply with the one or more IDC policies, or
reverting to legacy behaviors, comprising using a power management (PM) bit or stopping a source of IDC, for a defined period of time.

24. The method of claim 22, wherein the first network device comprises a non-access point (AP) station (STA), the second network device comprises an access point (AP) or a non-AP STA, and the first network device connects to the second network device via one or more communication links.

25. A system of a first network device, comprising:
one or more computer processors; and
one or more memories collectively containing one or more programs, which, when executed by the one or more computer processors, perform an operation, the operation comprising:
transmitting an in-device coexistence (IDC) policy announcement, wherein the IDC policy announcement is received by a second network device, and the IDC policy announcement comprises one or more IDC policies supported by the first network device;
monitoring one or more characteristics of reported unavailability windows to determine whether the second network device violates the one or more IDC policies; and
in response to detecting a violation of the one or more IDC policies, transmitting an IDC policy enforcement message to the second network device, the IDC policy enforcement message comprising a teardown frame to cancel the one or more IDC policies confirmed by the first network device.
